(19) United States
(12) Patent Application Publication
(10) Pub. No.: US 2026/0301020 A1
(43) Pub. Date: Oct. 1, 2026

(54) DATA PRIVACY-PRESERVING ENTITY-LEVEL DATA USING TRANSACTION-BASED CALIBRATION

(71) Applicant: ABCS INSIGHTS Inc., Kissimmee, FL (US)

(72) Inventors: Jerome Shimizu, Kissimmee, FL (US); Michael Sheng, Orlando, FL (US)

(21) Appl. No.: 19/212,472

(22) Filed: May 19, 2025

Related U.S. Application Data
(60) Provisional application No. 63/781,944, filed on Apr. 1, 2025.

(51) Int. Cl. G06Q 30/0242; G06Q 20/38

(52) U.S. Cl. CPC G06Q 30/0244; G06Q 20/389

(57) ABSTRACT

Systems and methods for generating projected store-level event-based interaction datasets using calibration techniques by accessing event-based interaction data from a plurality of users, where each event reflects a product transaction at a retail location. Supplemental user activity data is accessed from third-party databases. A projection factor is computed based on discrepancies between the interaction dataset and the supplemental data, the projection factor being indicative of underreporting in the observed data. The system applies the projection factor to scale the partial dataset into a projected dataset that estimates full consumer activity at a store or regional level. This projected dataset can be used to enhance targeted content delivery, improve media planning, support marketing mix modeling, or estimate store-level product demand in scenarios where direct point-of-sale data is unavailable. The system enables accurate behavioral insights without requiring data directly from retailers.

### CLAIM OF PRIORITY

This application claims the benefit of priority under 35 U.S.C. § 119(e) to U.S. Provisional Patent Application Ser. No. 63/781,944, filed on Apr. 1, 2024, which is incorporated by reference herein in its entirety.

### BACKGROUND

Ad exposure technology measures whether and how consumers interact with advertisements across various mediums, including digital, out-of-home, in-store, and broadcast channels. These systems estimate ad reach and effectiveness. Ad exposure technology plays a crucial role in advertising analytics by tracking when, where, and how consumers encounter advertisements across multiple platforms. These technologies help attribute conversions to specific marketing touchpoints, distinguishing between direct and indirect influences on consumer behavior.

### BRIEF SUMMARY

Some embodiments pertain to innovative systems and methodologies for generating reconstructed store-level or DMA-level retail sales data using calibration models. Even when only partial receipt data is available, the system integrates consumer-level transaction records from diverse sources and applies projection factors to estimate full retail activity. By accounting for sampling rates, demographic skews, store-specific reporting gaps, and receipt submission inconsistencies, the system enables advertisers, analysts, and marketers to approximate true sales performance at the store or regional level—without relying on direct data from retailers.

### BRIEF DESCRIPTION OF THE SEVERAL VIEWS OF THE DRAWINGS

In the drawings, which are not necessarily drawn to scale, like numerals may describe similar components in different views. To identify the discussion of any particular element or act more easily, the most significant digit or digits in a reference number refer to the figure number in which that element is first introduced. Some non-limiting examples are illustrated in the figures of the accompanying drawings in which:

FIG. 1 illustrates an aspect of the subject matter in accordance with one embodiment.

FIG. 2 illustrates an example method for generating a projected store-level event-based interaction dataset using supplemental user activity data to correct for underreporting, and modifying a targeted content campaign based on the projected data, according to some examples.

FIG. 3 illustrates a system architecture that enables the calibration of electronic interaction data using multiple sources of transaction log data, and applies the resulting calibrated dataset to drive targeted advertising campaigns, retargeting strategies, and media placement decisions, according to some examples.

FIG. 4 is a diagrammatic representation of a machine in the form of a computer system within which a set of instructions may be executed to cause the machine to perform any one or more of the methodologies discussed herein, according to some examples.

FIG. 5 is a block diagram showing a software architecture within which examples may be implemented.

FIG. 6 illustrates a machine-learning pipeline, according to some examples.

FIG. 7 illustrates training and use of a machine-learning program, according to some examples.

### DETAILED DESCRIPTION

Conventional consumer analytics systems that rely solely on electronic receipt data—such as user-scanned receipts or email-parsed digital receipts—are often incomplete and biased. These systems depend on consumers to actively submit or capture purchase data, which introduces inconsistencies, missing entries, and demographic skews in the dataset. For example, certain user groups may be more diligent in scanning receipts, while others may fail to submit them due to forgetfulness, lack of incentive, or technical issues. As a result, insights generated from this raw receipt data may not accurately represent true market behavior, leading to flawed segmentation, biased penetration estimates, and suboptimal decision-making.

One of the fundamental problems with relying solely on receipt data is the inability to detect missing interactions. If a consumer makes ten store visits but only submits receipts for three, the system has no way of knowing that seven interactions are missing. This partial visibility distorts behavior models, underestimates product or brand loyalty, and fails to capture the full spectrum of shopping frequency or product usage patterns. Such gaps are particularly problematic in high-frequency retail environments like grocery or convenience stores, where consumers often make routine purchases that go unrecorded.

Additionally, traditional systems that do not incorporate credit card or bank transaction data are unable to quantify how incomplete the receipt data truly is. Without an independent baseline of consumer activity, such as a transaction log that shows all spending activity across merchants, there is no reliable reference point to project the actual volume of missing data. As a result, these systems resort to probabilistic models or population-level estimates that fail to personalize corrections for individual consumers or geographies, thereby reducing the effectiveness of any downstream insights.

The interaction calibration system disclosed herein overcomes these limitations by integrating receipt data with external transaction log data—such as credit card records or bank-level purchase histories—to identify discrepancies and compute personalized projection factors. Unlike traditional approaches, this system does not assume receipt data is complete; instead, it uses independent, high-fidelity transaction logs to determine how many real-world interactions were missed by the receipt system. For example, if a user made eight transactions at a retailer according to their credit card log but only submitted three receipts, the system infers a missing data gap and calculates a projection factor of approximately 2.67×.

The system then applies this projection factor to scale the user's observed receipt data, creating a calibrated interaction dataset that more accurately reflects their true behavior. This calibration process can be executed at various levels of granularity—individual users, households, zip codes, or designated market areas (DMAs)—allowing analysts and marketers to draw conclusions with much greater confidence. For instance, brand penetration can be measured not just from partial receipt data but from a corrected dataset that approximates true consumer exposure, frequency, and product loyalty.

Moreover, the system supports data fusion across multiple sources and modalities. It can normalize receipt data from diverse channels (e.g., email-scraped, app-uploaded, or OCR-scanned paper receipts) and compare it against structured transaction logs from different financial institutions. Even when these data sources are formatted differently or originate from non-communicating systems, the system harmonizes them into a unified schema, detects overlap or missing entries, and recalibrates accordingly. The result is a more complete and unbiased dataset, capable of supporting advanced behavioral analysis, targeting, and performance measurement.

Finally, this system allows calibrated datasets to feed into downstream marketing operations, including targeting optimization, retargeting strategies, consumer segmentation, and inventory forecasting. By grounding insights in a more complete view of user behavior, businesses can improve the precision of decision-making while reducing reliance on guesswork or biased datasets. The interaction calibration system thus enables a more accurate, scalable, and data-rich foundation for consumer intelligence and market measurement.

### System Architecture for Interaction Calibration and Behavioral Modeling

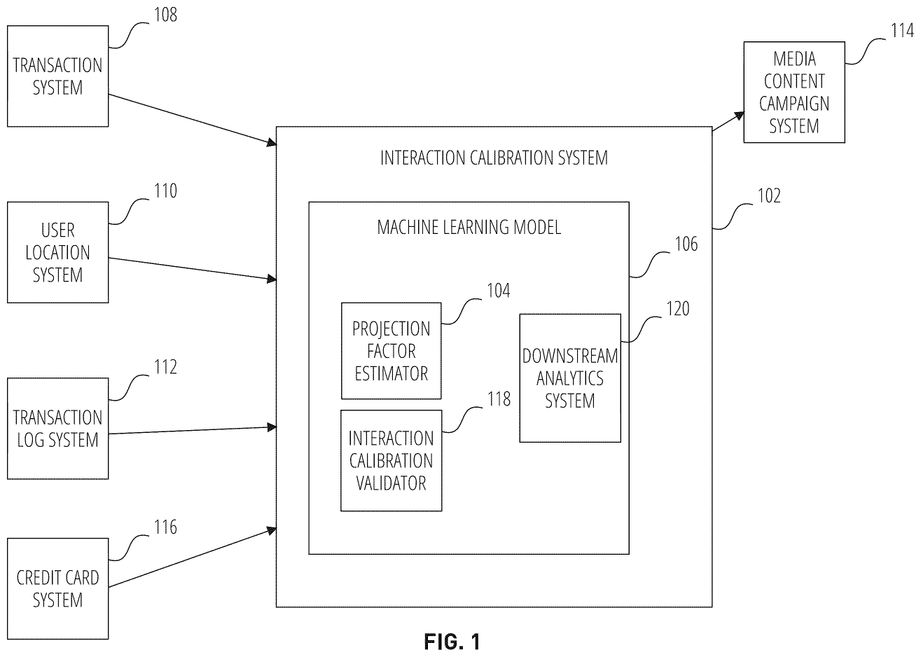

FIG. 1 illustrates an example system architecture 100 for calibrating consumer interaction datasets by reconciling observed electronic interaction data with independently sourced transaction log data, according to some embodiments. The system includes an interaction calibration system 102 that interfaces with a variety of external data sources—including receipt uploads, geolocation signals, payment records, and other transaction logs—to detect discrepancies in user behavior data and generate projection-adjusted datasets for downstream analysis.

The interaction calibration system 102 includes a machine learning model 106 that supports multiple subcomponents: a projection factor estimator 104 configured to identify and quantify underreporting of user interactions by comparing transaction volumes across disparate data feeds; an interaction calibration validator 118 trained to evaluate the accuracy and representativeness of the adjusted dataset; and a downstream analytics system 120 for delivering calibrated outputs to external measurement, optimization, or modeling systems.

The architecture further includes several external systems that provide complementary data streams:
A transaction system 108, which gathers structured receipt data from user uploads, mobile apps, retailer platforms, or third-party aggregators;
A user location system 110, which supplies geofencing or mobile-derived store visit logs to help infer presence in retail locations, even absent receipts;
A transaction log system 112, which collects broader payment signals—such as credit or debit transactions—from retail banks, payment networks, or aggregator APIs;
A credit card system 116, which serves as an overlapping or supplemental source of financial activity data used to cross-validate interaction coverage;
A media content campaign system 114, which may consume the calibrated interaction datasets and associated metrics (e.g., product-level demand, regional engagement, household-level conversion rates) to optimize advertising spend, campaign design, or market strategies.

The transaction system 108 transmits receipt data to the interaction calibration system 102, either in real time or through periodic batch processing. The data transmission may be conducted via direct APIs, secure data pipelines, file transfer protocols, or cloud-based synchronization mechanisms. Once ingested, this receipt data becomes part of the electronic interaction dataset used to measure and model consumer purchasing behavior.

The interaction calibration system 102 utilizes this receipt data to assess the completeness of observed user interactions, comparing it against external sources such as credit card transactions or store visit logs. For example, if a user uploads three receipts from a grocery store, but other systems indicate eight visits to that store during the same time period, the transaction system 108 helps provide the observed data necessary to trigger calibration. This data serves as a critical input to the projection factor estimator 104 and the interaction calibration validator 118 within the machine learning module 106, enabling the system to identify gaps, scale interaction counts, and refine downstream analytics outputs.

The user location system 110 refers to one or more systems that collect and report geolocation data associated with users' physical movement patterns and store visit behavior. These systems may rely on GPS, Wi-Fi triangulation, Bluetooth beacon networks, mobile app geofencing SDKs, smart device logs, or venue entry systems to determine when and where a user enters or exits a commercial environment.

Geolocation data from the user location system 110 is transmitted to the interaction calibration system 102 to assist in estimating real-world shopping activity. Timestamps and spatial coordinates are analyzed to determine visit frequency and validate whether an observed receipt is representative of the user's full purchasing behavior. For example, if location data shows that a user visited a retail store seven times in a month but submitted only two receipts, the system infers underreporting and uses this signal to adjust interaction estimates. This behavioral signal feeds into the projection factor estimator 104 to support calibration logic and can be validated via the interaction calibration validator 118.

The transaction log system 112 comprises systems responsible for capturing financial transaction records that are not limited to traditional receipt data. This includes credit card statements, bank logs, payment aggregator feeds, and electronic payment data from both online and offline commerce environments. These logs may originate from distinct financial institutions or aggregators and often lack item-level granularity but provide a robust source of timestamped merchant-level activity.

The transaction log system 112 sends these transaction records to the interaction calibration system 102 to enable cross-validation of the electronic interaction dataset. For instance, if a consumer's credit card history reflects eight transactions at a specific merchant, but the system only has three uploaded receipts, the discrepancy helps calculate a projection factor through module 104. These transaction logs help establish the total volume of consumer economic activity and serve as a foundational benchmark for scaling partial datasets into more complete, calibrated views of real-world behavior.

The credit card system 116 functions as an overlapping or supporting data source, offering access to user-level payment history via networks such as Visa, Mastercard, or AmEx; financial institutions; or digital wallets. This system supplies anonymized transaction data—such as timestamps, merchant names, and purchase amounts—which can help detect activity that may not be present in the receipt data alone.

This data is ingested by the interaction calibration system 102 and used to confirm whether unreported visits or purchases occurred, thereby increasing confidence in applying a projection multiplier. These signals feed into both the projection factor estimator 104 and the interaction calibration validator 118 to determine the appropriate scaling adjustments needed to produce a more accurate, representative dataset.

The credit card system 116 sends transaction log data to the interaction calibration system 102 to assist in validating and refining the accuracy of observed electronic interaction data (e.g., receipts). This transaction data enables the system to:
Determine whether a user made purchases during timeframes or at merchants where no corresponding receipts were submitted (coverage gap detection),
Identify whether the transaction aligns with an existing merchant or product category represented in the receipt data (brand-level validation),
And assess whether the timing and location of a card-based purchase support or contradict the interaction patterns reflected in submitted receipts or location signals.

These credit card signals are processed by the interaction calibration validator 118, which evaluates the likelihood that financial activity not recorded in the receipt data still represents a valid interaction. In cases where receipt data is missing or sparse, these transactions help reinforce calibration assumptions and enable the system to produce a more complete representation of consumer behavior. This supports robust, receipt-independent calibration that increases reliability across diverse merchant environments and user segments.

The interaction calibration system 102 serves as the central processing engine that ingests, integrates, and reconciles data from multiple external systems—including the transaction system 108, user location system 110, transaction log system 112, and credit card system 116—to detect discrepancies in observed consumer behavior and project a more accurate interaction dataset.

Within system 102, internal subsystems perform various functions such as projection factor estimation, user-level reconciliation, machine learning-based inference, and calibration verification. Upon receiving upstream data, the system aligns timestamps, reconciles user identifiers (e.g., device ID, hashed email), and harmonizes data formats across structured and semi-structured sources. It supports both real-time and batch processing, and can operate in either deterministic (e.g., exact user match) or probabilistic (e.g., inferred user behavior) calibration modes.

The system outputs key metrics such as projected purchase frequency, estimated total event volume, segment-level coverage gaps, and calibration confidence scores. These metrics are used by the downstream analytics system 120 and can be visualized in internal dashboards, exported to BI tools, or used to inform business decisions in campaign targeting, sales forecasting, or supply chain management.

The machine learning model 106 is a core component within the interaction calibration system 102. It automates key processes such as projection factor estimation, receipt validation, and downstream calibration scoring. The model is trained on large datasets comprising transaction log records, receipt data, location activity, and historical behavior benchmarks.

The model is adaptive and continuously retrained to reflect evolving user behavior patterns, product trends, and channel-specific reporting characteristics. In some implementations, the model runs in real time—flagging discrepancies as new data is ingested—while in others, it operates as a batch processor over aggregated datasets to produce regional or segment-level calibration factors.

Within the machine learning module 106 are specialized submodules: the projection factor estimator 104, which calculates scaling multipliers based on observed vs. expected event volume; the interaction calibration validator 118, which confirms the plausibility and integrity of calibration logic; and the downstream analytics system 120, which converts calibration outputs into actionable business intelligence.

The projection factor estimator 104 is a subcomponent of the machine learning model 106 that determines how much to scale observed interaction data—such as uploaded receipts—to better reflect a user's actual purchasing behavior. It ingests structured data from sources such as electronic receipts, transaction logs, geolocation feeds, and behavioral history, and applies statistical models or AI techniques to detect discrepancies between observed interactions and expected transaction volume.

For example, if a user submitted two grocery receipts during a month but their credit card logs indicate eight visits to the same store, the projection factor estimator 104 may assign a scaling factor of 4.0. These projection factors are adjusted based on dimensions such as user demographics, visit frequency, merchant type, known product purchasing cycles, or even geographic market characteristics. The resulting output is a calibrated multiplier that is applied to the interaction dataset to correct for underreporting or partial data coverage.

The interaction calibration validator 118 is a specialized machine learning module that evaluates the plausibility and integrity of the calibrated dataset. It examines both raw and projected data to determine whether inferred interactions are supported by corroborating evidence—such as credit card transactions, repeated visit patterns, loyalty program records, or behavioral norms. The validator may assign confidence scores to each projection, filter out statistically anomalous scaling results, or adjust projection factors based on contextual inputs such as holiday shopping behavior or known limitations in receipt collection modalities (e.g., manual uploads vs. email scraping).

The interaction calibration validator 118 works closely with the projection factor estimator 104 to ensure that calibration logic is grounded in real-world behavior and does not overfit or misrepresent user activity. Together, they generate a balanced and reliable calibrated interaction dataset that supports higher-accuracy downstream analysis.

The downstream analytics system 120 consumes the calibrated interaction data and produces actionable business intelligence for teams that rely on accurate consumer behavior insights. This may include generating updated product penetration models, purchase frequency estimates, loyalty segmentations, or market share assessments. The system may also simulate the impact of different calibration scenarios—such as altering demographic correction factors or receipt submission assumptions—and project how these changes affect brand-level insights or inventory planning.

In some implementations, system 120 interfaces with external measurement or campaign management tools, enabling stakeholders to use the recalibrated dataset to adjust audience targeting, update media spend allocations, or refine supply chain forecasts. By integrating real-time and historical calibration metrics, the downstream analytics system ensures that strategic decisions are made on a statistically robust foundation.

The media content campaign system 114 is a downstream component that receives calibration outputs and strategic insights from the interaction calibration system 102. Based on these insights, system 114 supports planning, targeting, and performance assessment for media campaigns by enabling stakeholders to better understand true consumer activity patterns—corrected for underreporting or data fragmentation.

System 114 consumes outputs from the downstream analytics system 120, which may include:
Adjusted market penetration estimates for specific products or brands;
Region-specific purchase behavior based on home ZIP code analysis;
Audience segments refined by calibrated interaction frequency or loyalty trends;
Campaign performance diagnostics corrected for partial receipt data or missing product-level transactions.

For example, if calibration reveals that sales of a promoted snack brand were underreported in rural areas due to lower digital receipt penetration, system 114 can recommend reallocating media spend or messaging strategies to better reflect the actual conversion performance in those areas. Similarly, if a household-level analysis shows stronger-than-expected brand affinity among certain age or income groups, campaign targeting parameters can be refined to emphasize those demographics.

The media content campaign system 114 may also integrate with campaign management platforms, data clean rooms, or demand-side platforms (DSPs) to apply these recommendations across media channels—including digital advertising, retail media networks, or email marketing. It can maintain a configuration database that stores calibration-aware campaign metadata, such as:
Product or brand IDs being promoted;
Geographic or demographic targeting cohorts;
Historical performance benchmarks (pre-vs. post-calibration);
Adjusted audience sizing based on projected engagement behavior;
Triggers for automated reallocation or message testing.

By working in tandem with the projection factor estimator 104 and downstream analytics system 120, the media content campaign system 114 helps close the calibration-feedback loop—ensuring that advertising decisions, spend allocation, and measurement frameworks are based on the most accurate view of user interactions available. It bridges the gap between consumer behavior as captured and consumer behavior as actually observed, helping brands and agencies avoid misallocation due to incomplete or biased data.

### Entity-Level Data Using Transaction-Based Calibration

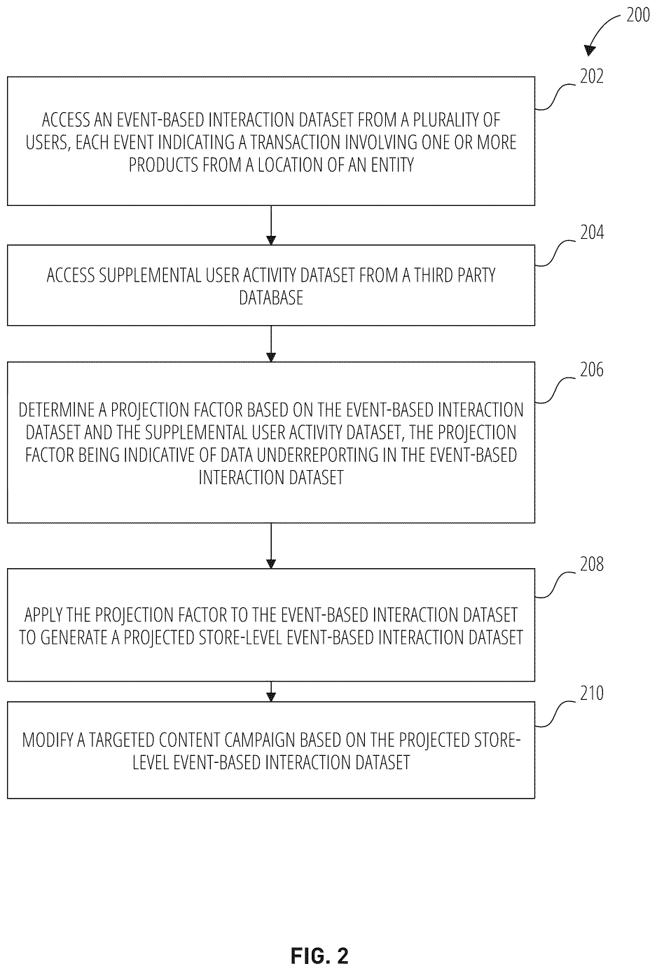

FIG. 2 illustrates an example method 200 for generating a projected store-level event-based interaction dataset using supplemental user activity data to correct for underreporting, and modifying a targeted content campaign based on the projected data, according to some examples. Although the example method 200 depicts a particular sequence of operations, the sequence may be altered without departing from the scope of the present disclosure. For example, some of the operations depicted may be performed in parallel or in a different sequence that does not materially affect the function of the method 200. In other examples, different components of an example device or system that implements the method 200 may perform functions at substantially the same time or in a specific sequence.

At block 202, the event projection system accesses an event-based interaction dataset from a plurality of users. Each event can indicate a transaction involving one or more products from a location of an entity.

In some embodiments, the event-based interaction dataset may include structured or unstructured records reflecting consumer transactions with specific products or services at a physical or digital location of an entity. While these events may originate from digital receipts submitted through consumer-facing applications, the event-based interaction dataset is not limited to receipt data alone.

For example, event-based interaction data can include: digital order confirmations captured from connected email accounts or mobile applications; loyalty or rewards program activity logs indicating check-ins, redemptions, or repeat visits; QR code or barcode scan logs from shopping apps; itemized purchase summaries from online or in-app purchases; and digital wallet confirmations tied to product-level transactions. In some cases, interaction data can also include inferred purchase behavior, such as proximity-based store visits captured via geolocation services, product engagement within mobile shopping interfaces, or linked app behavior consistent with consumer purchase activity.

The event-based interaction dataset includes event records that indicate transactions involving one or more products at a physical or digital location of an entity, such as a store, restaurant, or e-commerce platform.

Each event in the dataset reflects an observed instance of consumer interaction with a product or service and may originate from a variety of data collection channels. While some events may be derived from traditional receipt records, the dataset can include a broader range of interaction types.

In some embodiments, the event-based interaction dataset may include structured or semi-structured records such as digital receipts retrieved from email confirmation scraping, in-app purchase history, integrated POS systems, or external receipt aggregation services. These event records can be stored in machine-readable formats such as JSON, XML, or tabular log schemas, and may include data fields such as product-level line items, transaction timestamps, store or merchant IDs, item SKUs, applied promotions, pricing information, and geographic metadata for the location of the entity.

In some implementations, the event-based interaction dataset may include scanned images of physical receipts that have been processed using optical character recognition (OCR) to extract structured product- and merchant-level data. For example, a user might upload a photo of a printed receipt from a grocery store, which the system processes to identify individual items, store identifiers, timestamps, and pricing details—thereby converting an analog interaction into a structured event within the dataset.

Beyond receipt-derived interactions, the event-based projection system can ingest alternative forms of consumer activity that reflect engagement with a product or location, even if a full receipt is not available. For instance, the event-based interaction dataset may include store check-ins via loyalty programs, barcode scans from mobile coupon redemptions, additions or removals of items from a digital shopping list, or commands issued through voice-activated purchase assistants. These event types may signal consumer intent, consideration, or proximity to purchase, and are treated as valid events within the dataset, even if they do not include itemized transaction records.

Each event is associated with a specific user and may be linked to that user through anonymized identifiers, hashed device IDs, app account IDs, or retail loyalty credentials. By preserving this linkage at the individual user level, the system enables more precise calibration workflows—particularly for identifying discrepancies, estimating projection factors, and maintaining user-level granularity in downstream store-level projections.

The system accesses a first event-based interaction record, which was captured through a user-facing application after the user completed a purchase at a retail location. This interaction record may have been generated by the user uploading a photo of their receipt via a mobile app, or by submitting transaction details through an integrated scanning or OCR feature.

In parallel, the system accesses a second interaction record sourced directly from the point-of-sale (POS) infrastructure of the same or similar retail location. This record may be obtained through direct integration with the retailer's transaction system, or indirectly via a third-party data aggregator that collects structured transaction data in real time from POS terminals.

By accessing both user-submitted and system-sourced interaction records, the event projection system is able to compare, validate, and reconcile differences between data sources. This enables the system to detect underreporting, estimate missing data, and enhance the accuracy of the projected store-level interaction dataset.

At block 204, the event projection system accesses supplemental user activity dataset from a third party database.

The event projection system retrieves supplemental user activity datasets from third-party sources such as credit card networks, issuing banks, digital wallets, or financial data aggregators. These datasets contain structured records of financial transactions performed by users through various transaction instruments, including debit cards, credit cards, prepaid cards, and linked mobile payment apps.

Each record can include a transaction timestamp, merchant name or ID, merchant category code (MCC), total transaction amount, and a unique but anonymized user identifier (e.g., hashed account or device ID). Unlike traditional receipt records, these financial logs do not include line-item product details, but they provide comprehensive coverage of consumer activity at merchant and store levels.

The supplemental dataset may include transactions captured across multiple institutions and card networks, allowing the system to consolidate fragmented user activity into a single unified view. For example, a user may shop at a grocery store five times in a week using different credit cards.

Even if the event-based interaction dataset only captured one of those visits, the credit card log may contain all five. These datasets may be made available via secure APIs or batch data exports from financial partners and are often maintained in compliance with privacy regulations, with personal identifiers removed or tokenized to preserve anonymity.

In some cases, the supplemental dataset may also provide metadata associated with user geography (e.g., billing zip code), card type (e.g., rewards card vs. basic debit), or channel of transaction (e.g., in-person POS swipe vs. online checkout). These attributes provide useful contextual signals for interpreting user purchase behavior and allow the system to segment the data by geography, demographic profile, or merchant category. The system may ingest and standardize datasets from multiple financial partners, normalizing merchant names and time zones, and mapping transactions to specific store locations using internal or third-party merchant reference databases.

Importantly, these financial logs are typically more complete than receipt-based interaction data, which may suffer from selective submission, data loss, or demographic skews. Because credit and debit card transactions are directly captured at the point of transaction and processed through centralized financial infrastructure, they represent a near-complete signal of user spending activity.

In some embodiments, the supplemental user activity dataset may include financial transaction log data, which can be accessed from third-party databases such as issuing banks, credit card networks, mobile payment platforms, or financial data aggregators. These datasets may include either itemized or non-itemized transaction records associated with various consumer payment methods, and reflect real-world purchase activity at the merchant or store level. Although credit card history data is a common example, the supplemental dataset is not limited to traditional credit card statements.

The supplemental dataset may include other forms of transaction records such as debit card logs, buy-now-pay-later (BNPL) installment payment activity, mobile wallet usage, and peer-to-peer or direct-to-merchant transfers via bank accounts. In some instances, these records are collected through financial APIs, open banking platforms, or anonymized data feeds licensed from financial infrastructure providers. The financial logs may contain attributes such as transaction timestamps, merchant names, amounts spent, payment channels (e.g., in-store vs. online), and anonymized or hashed user identifiers.

In some embodiments, the transaction instrument used to generate the log entries may be a credit card linked to a user account, and the system can retrieve this information through integrated APIs provided by card-issuing institutions or payment processors. However, transaction instruments are not limited to credit cards. They may also include debit cards, prepaid cards, retailer-specific payment cards, mobile wallets, virtual cards, and payment tokens generated in secure, encrypted environments. In some cases, the system captures ACH transfers, direct deposits, or digital disbursement methods that consumers use in retail environments.

By supporting a broad array of financial data sources and transaction instruments, the event projection system is designed to ingest highly diverse payment activity across the consumer population. These datasets form the foundation of the supplemental user activity dataset, allowing the system to compare observed behavior in the event-based interaction dataset with a more complete picture of real-world transaction volume—enabling accurate calibration through projection factor analysis.

In some embodiments, the supplemental user activity dataset accessed by the event projection system includes consumer-level transaction frequency data from third-party databases. These databases may contain aggregated or pseudonymized financial activity logs sourced from banking APIs, credit card providers, digital wallet systems, or financial data partners.

The dataset can provide an overview of how frequently individual consumers transact with a particular type of store or entity, as inferred from transaction timestamps, merchant categories, and unique consumer identifiers. This supplemental dataset may be structured to show historical transaction activity at the individual level, such as how many times a particular user has completed a transaction at a grocery store over a monthly or weekly period.

These consumer-specific activity logs may not contain line-item detail of what was purchased, but they do offer a reliable signal of visit frequency, merchant interaction, and spend behavior over time. In some implementations, these datasets may be anonymized using hashed identifiers to maintain user privacy while still allowing linkage to corresponding users in the event-based interaction dataset.

The event projection system may access this information through financial data exchange platforms or open banking frameworks that allow consumers to grant permission to share their transaction history. Alternatively, the system may ingest aggregated behavioral norms generated by large-scale financial analytics providers that offer user-level behavioral benchmarks. These benchmarks can be derived from representative consumer panels, loyalty program usage, or spending models built from anonymized credit card data.

Each user record in the supplemental dataset may contain fields such as user ID (e.g., anonymized), number of transactions per merchant category, visit frequency per week or month, and location metadata. By accessing this structured user-level data, the event projection system can generate a high-fidelity view of what typical consumer behavior looks like across retail environments, even if the receipt capture dataset lacks full coverage.

In some cases, the event projection system accesses a supplemental user activity dataset that includes externally sourced retailer-level sales benchmarks. These benchmarks may be retrieved from publicly available financial filings, such as quarterly or annual SEC disclosures (e.g., 10-K or 10-Q reports), or from private data partnerships with loyalty card programs, syndicated data aggregators, or market intelligence firms. In some cases, these sources provide store-level or region-level figures for total revenue, average basket size, unit sales by category, or time-based performance metrics.

SEC filings may specify total revenues earned by a retail chain or specific geographic regions, the number of stores in operation, and average revenue per store during a particular reporting period. When available, these reports can serve as reliable ground-truth references to calibrate independently collected datasets. For example, a major grocery chain's 10-K may disclose that its average store earns $2 million in sales each quarter. This serves as a top-down reference point for benchmarking.

Additionally, the supplemental dataset may include revenue metrics shared by loyalty program operators. These datasets may reflect comprehensive internal sales summaries, including redemptions, customer frequency, and gross merchandise volume per store. Other sources may include analyst estimates, investor briefings, or third-party retail analytics reports that provide projected revenue ranges for competitive benchmarking.

The system is configured to interpret this supplemental data in a structured format. Each benchmark entry may include store identifier, reporting timeframe, total sales value, associated geographic metadata (e.g., zip code or DMA), and data source confidence scores. This structured external dataset can then be joined with event-based interaction data collected from consumers (e.g., receipts, scanned product logs) in order to detect volume mismatches and data underrepresentation.

In some cases, the event projection system accesses supplemental user activity datasets that capture physical store traffic, such as geofencing logs or geolocation data. These datasets may be obtained from third-party mobility analytics providers, location intelligence platforms, cellular providers, or Wi-Fi-based in-store tracking systems. Each dataset typically records anonymized presence events, capturing the estimated number of individuals who physically entered or were near a specific store during a defined time period.

In some implementations, the system may access geofencing data that tracks when mobile devices cross into a predefined geographic boundary around a store—such as a 50-meter radius around a retail location. This information can be aggregated to determine how many unique users were present within the store's perimeter, how long they stayed, and how frequently they returned. Depending on the data provider, this may include latitude-longitude coordinates, device dwell times, time-of-day visit logs, or anonymized user identifiers tied to location histories.

Alternatively, footfall data may be collected directly from the store itself or via indoor analytics vendors that monitor entries and exits through sensors, smart carts, or overhead camera systems. These sources can yield highly granular store visitation counts, broken down by hour, day, or week. Some providers may even offer contextual segmentation, such as peak vs. off-peak hours, demographic segmentation based on device patterns, or cross-store shopper overlap.

At block 206, the event projection system determines a projection factor based on the event-based interaction dataset and the supplemental user activity dataset, the projection factor being indicative of data underreporting in the event-based interaction dataset.

The event projection system uses the supplemental credit or bank account dataset to identify discrepancies between observed user activity in the event-based interaction dataset and actual transaction patterns. For example, suppose the event-based dataset contains five scanned receipts from users who visited a particular grocery store during a specified time window. The system checks the supplemental credit card logs for that same store and user group and finds that the same users had a total of fifty financial transactions at the merchant during that window. This suggests that only 10% of user transactions were captured through the receipt data.

To quantify the gap, the system calculates a projection factor. In one example, the system divides the number of credit card transactions by the number of corresponding receipt-based events. In the above case, a 50-to-5 ratio yields a projection factor of 10×. This projection factor reflects the magnitude of underreporting in the primary dataset and is used to scale observed metrics accordingly. The system may also compute projection factors across various dimensions such as per-user, per-store, per-merchant, per-week, or per-region, depending on the level of granularity required for downstream applications.

In some implementations, the system refines projection factor calculations by excluding anomalous or incomplete data points. For instance, if a user frequently pays in cash but only uses a card once, their projection factor might be skewed. The system may apply filters based on merchant consistency, purchase frequency, or known user behaviors.

The system can exclude returns, voided charges, or non-qualifying transactions based on MCC codes or transaction descriptions to ensure accurate scaling. Additionally, to prevent overfitting, the system may smooth or average projection factors across a broader user cohort when individual-level data is too sparse.

In some cases, the event projection system compares the observed receipt-based activity for a user with their known transaction frequency from the supplemental dataset to compute a projection factor. For example, if a user's event-based interaction dataset shows only three retail visits recorded over a month, but their bank or credit card activity shows twelve distinct transactions at similar merchants during the same time period, the system determines that only 25% of that user's true behavior is reflected in the receipt data. This yields an individual-level projection factor of 4× for that user.

The system performs this comparison across a large number of users, generating personalized projection factors for each one based on their observed vs. expected interaction frequency. These individual factors help the system correct for underreporting that occurs due to incomplete receipt submissions, missed scans, or consumer drop-off in participation. In effect, the system recalibrates the contribution of each user to reflect a more realistic level of shopping activity.

In some cases, the event projection system compares the total sales captured in the event-based interaction dataset with the benchmark data retrieved from external sources such as SEC filings or loyalty programs to compute a projection factor. For instance, if the receipt data collected for a given store shows $200,000 in total sales during Q1, but the SEC filing for that retail chain indicates that the same store typically generates $2 million in quarterly sales, the system identifies a 10× discrepancy. This yields a projection factor of 10, which is used to scale the observed data up to reflect estimated real-world activity.

The system can apply this process across multiple store locations, generating a projection factor for each store individually. This approach allows the system to detect not only overall underreporting but also spatial variability in receipt data coverage. For example, urban locations might be well represented in consumer-submitted data, while rural or suburban stores might be under-sampled, requiring a higher correction factor. By aligning reported sales figures with observed consumer behavior, the system produces more reliable projections at the store, regional, or even national level.

In some implementations, the system assigns confidence levels to each projection factor based on the quality and timeliness of the supplemental data source. For example, factors derived from SEC filings may receive high confidence scores due to their audited nature, while factors based on analyst estimates may be weighted less heavily. The system may also normalize across varying timeframes by interpolating weekly sales from quarterly filings, ensuring alignment with the temporal granularity of the receipt data.

The final projection factor can then be applied to the observed receipt dataset to generate a projected store-level event-based interaction dataset. This calibrated dataset is significantly more actionable than raw receipt data, enabling advertisers and analysts to conduct store-level performance analysis, marketing mix modeling, and retail forecasting with improved fidelity—even in the absence of first-party retailer data.

In some cases, the event projection system uses the geofencing or footfall-based store traffic data to identify discrepancies between physical store visits and captured purchase events in the event-based interaction dataset. For example, if foot traffic logs indicate that 5,000 people entered a given store in a specific week, but only 250 purchase events were recorded in the interaction dataset (e.g., submitted receipts, app orders, barcode scans), the system infers that only a small fraction of real-world purchases were captured. This can yield a projection factor of 20×, indicating significant underreporting of actual transactions.

The system computes this projection factor by dividing the estimated number of in-store visitors by the number of observed interaction events. Depending on the context, the projection factor may be adjusted to account for the expected conversion rate—i.e., the percentage of visitors who typically make a purchase. For example, if historical benchmarks or retailer norms suggest a 70% conversion rate, the system would use this baseline to refine its projection factor accordingly (e.g., expecting 3,400 purchases out of 5,000 visits rather than the full 5,000).

In some cases, another factor is used to dampen the projection factor. As it is expected that not everyone makes a purchase, let alone, a purchase of a particular product, on every visit, the system can reduce the projection factor, such as based on demographics, zipcode, or other user data. A certain demographic or user from a zipcode can be more prone to purchasing a particular product than another user.

In some implementations, the system cross-validates multiple sources of foot traffic data to ensure projection accuracy. For example, it may compare geofencing logs from multiple mobile data providers or triangulate footfall estimates using both GPS and in-store Wi-Fi signals. The system may also apply filters to remove anomalies, such as dwell times under 30 seconds (which may reflect passersby rather than actual shoppers), or adjust for repeat visits by the same user within a short period.

This projection logic enables the system to scale up the observed event-based interaction dataset in a statistically grounded way, using real-world visitation data to compensate for underrepresentation in digital receipts or logged purchase signals. The resulting projection factor is applied to create a projected store-level event-based interaction dataset that more accurately reflects total consumer behavior, facilitating downstream applications such as inventory forecasting, ad performance optimization, and campaign attribution.

In some implementations, the system applies additional statistical and behavioral models to refine the projection factor applied to the event-based interaction dataset. These models account for device usage patterns, temporal variability, product characteristics, and user demographics to increase the fidelity of projected store-level purchase behavior.

For example, the system may apply device-level sampling rate adjustments, where the system estimates what percentage of users who shopped at a given retailer actually uploaded receipts through the application. If only 1% of app users who visit a particular merchant regularly submit receipts, the system can scale observed interaction events by a factor of 200 to better approximate total purchase activity for that merchant.

The system may also apply time-window discrepancy adjustments, identifying temporal gaps or fluctuations in reporting patterns. For instance, during holiday weeks or periods of heightened shopping activity, receipt submission rates may decline due to scanning fatigue or technical outages. The system analyzes historical submission baselines and applies time-weighted correction factors to account for likely underreporting in these periods.

Another correction method includes product-level elasticity modeling, where the system leverages known consumption patterns for specific products. For example, if a staple item such as milk is typically purchased every 1.5 weeks, but the receipt dataset only contains one instance for a user over a month-long period, the system infers likely missing events and scales the data accordingly.

In some embodiments, the system performs geographic density modeling to compare the concentration of users in a given zip code to the known population or transaction volume for that region. If the system's user base constitutes only 1% of the local population and records 200 receipts, it can project 10,000 purchases to reflect population-level behavior.

The system may also utilize loyalty program matching. For users enrolled in retailer loyalty programs, it compares total transaction records in the loyalty logs against the number of receipts actually submitted to the event-based interaction dataset. Discrepancies in these matched users can be used to infer underreporting rates and apply those rates to users not in loyalty programs.

In some cases, basket size estimation is used to detect underreporting. The system compares the average basket size (e.g., $80 from historical store averages) against the average spend reflected in the captured receipts (e.g., $35). A significantly smaller reported basket size may indicate partial submission of purchases, prompting the system to apply a scaling multiplier to account for unrecorded items.

Demographic behavior modeling can further refine the projection. For example, younger users may be less diligent in scanning or uploading receipts, while coupon users or older demographics may be more consistent. The system applies segment-based multipliers tailored to expected behavior patterns.

The system also accounts for channel bias, where certain transaction environments—such as vending machines, fuel pumps, or quick-serve counters—are less likely to result in a receipt. The system applies merchant-type correction factors to adjust for this reduced likelihood of capture.

To anchor projections to external benchmarks, the system may employ panel or census comparisons. Receipt-derived data is compared to independent sources, such as Nielsen HomeScan panels, CPI datasets, or regional economic census figures. Undercoverage is then estimated by category, store type, or location, and the projection factor is adjusted accordingly.

In some embodiments, the system examines receipt submission modality discrepancies by comparing submission rates across channels such as mobile app uploads, email scraping, and OCR-based scans. For instance, if email scraping accounts for 80% of total captured receipts but OCR captures only 10%, the system identifies gaps and extrapolates the likely missing interaction events from the underperforming modality.

Additionally, the system may use return visit frequency modeling to determine if users are underreporting based on known visit frequency patterns. For example, if a grocery customer is expected to visit 1.5 times per week, but the receipt data reflects only one visit in two weeks, the system extrapolates additional likely visits.

POS receipt issuance rate is another factor. If a retailer is known to issue receipts only 70% of the time, the system corrects for the expected 30% of unlogged transactions based on known issuance rates.

Finally, the system may apply purchase frequency distribution models, such as negative binomial models, to estimate the expected number of transactions per user for a given product type. This helps calibrate projection factors for both high-frequency consumables and one-time or low-frequency purchases.

These correction models, when layered onto the core projection logic, enable the system to scale observed data with greater nuance, accounting for structural biases, behavioral patterns, and temporal inconsistencies across different users, products, and store environments.

At block 208, the event projection system applies the projection factor to the event-based interaction dataset to generate a projected store-level event-based interaction dataset. The system takes the observed, often incomplete, user-level interaction data and adjusting such data to reflect what the system estimates to be the actual total consumer behavior at a store, brand, product, or geographic level.

The event-based interaction dataset may include receipt-like data, digital confirmations, app-based orders, or other event signals that represent purchases. However, due to limitations in coverage or consumer reporting behavior, the dataset only reflects a partial view of the total market activity.

The system uses the projection factor—previously calculated based on supplemental data such as credit card logs, foot traffic estimates, or SEC filings—to rescale the dataset accordingly. For example, if the system identified a 10× projection factor for a particular store and time window, it means the receipt dataset is believed to cover only 10% of actual events. In such a case, if the original dataset includes 200 events for a specific product at that store, the projection system scales that value up to 1,000 projected events. This recalibrated dataset now serves as a more representative estimate of what occurred across the full consumer base—even though only a small sample was directly observed.

The projection process may be performed at various levels of granularity. In some cases, the projection factor is applied at the store and product level, while in other implementations, the factor may be store-wide, regional (e.g., DMA-level), or even segmented by demographic clusters. The system may apply different projection factors for different product categories, stores, or time periods, depending on how underreporting varies across those dimensions. The resulting projected dataset can include updated event counts, adjusted aggregate metrics (e.g., total spend, units sold), and recalculated shares or trends that reflect a synthetic approximation of real-world activity.

### Actionable Insights Based on Projected Event-Based Interaction Data

At block 210, the event projection system modifies a targeted content campaign based on the projected store-level event-based interaction dataset. After the event projection system has generated a projected store-level event-based interaction dataset, such data can be used to derive actionable insights that enhance targeted content delivery, audience segmentation, and media strategy optimization.

Because the projected dataset compensates for missing or incomplete signals in the original event-based interaction dataset—corrected via supplemental user activity data and projection factor modeling—it provides a more realistic representation of consumer behavior. This allows marketing analysts, media planners, and brand owners to make informed decisions about content deployment, regional allocation, and strategic prioritization of under-engaged audiences.

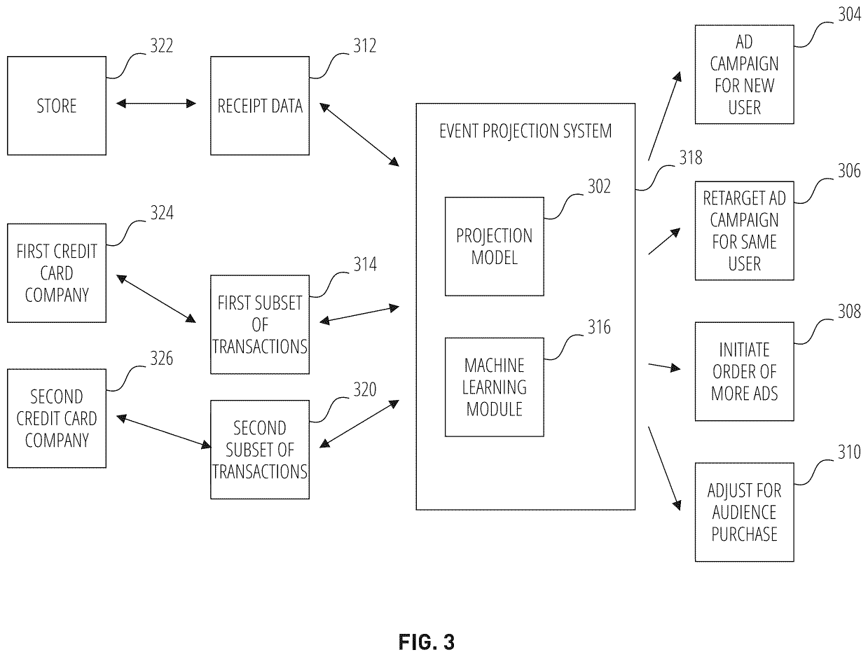

FIG. 3 illustrates how the event projection system applies projection factors to raw interaction data and third-party supplemental datasets to build a more comprehensive picture of consumer-product engagement. For example, event data sources may contain only partial records due to voluntary receipt upload, app usage limitations, or incomplete merchant integrations. To address this, the system accesses supplemental user activity datasets—such as credit card transaction logs or bank account histories—which provide a more complete picture of financial activity.

By comparing these datasets, the system computes a projection factor and uses it to scale the observed data into a more accurate projected dataset. This output can then be leveraged to assess engagement across different regions, merchant locations, product verticals, or consumer segments.

Using the recalibrated dataset, the system improves the accuracy of consumer classification and outreach. For example, if a user appears to have only two transactions with a particular brand within the raw event-based interaction dataset, but supplemental activity data reveals 10 visits, the projection system adjusts this profile accordingly.

As a result, the user is reclassified from a low-engagement customer to a frequent buyer, triggering content campaigns tailored to loyalty recognition or premium upselling. This ensures that personalized messaging—whether via mobile, email, or physical signage—reflects a user's true interaction frequency and affinity, rather than relying on underreported or inconsistent data.

Furthermore, insights derived from the projected dataset allow content providers and advertisers to shift campaign tactics across geographic or demographic segments. If underreported receipt activity in a specific DMA is corrected by the system's projection model to reveal previously hidden product interest, brands may choose to increase investment in those areas. Conversely, if projected data shows oversaturation in other markets, content frequency or ad spend can be scaled back. These types of adjustments—enabled by the correction of structural reporting gaps—are essential for demand forecasting and yield optimization in dynamic retail environments.

The projected dataset also supports time-series and behavioral trend analysis. Over multiple observation periods, the system detects shifting consumption habits, such as increases in trial rates, seasonal spikes, or churn risk. These patterns inform forward-looking targeting strategies, allowing content managers and advertisers to anticipate needs rather than simply react to observed history. Because the projections are built on multi-source inputs rather than just receipt-based data, they more reliably reflect how consumers behave in real-world settings, particularly in cases where direct data access is unavailable.

FIG. 3 also depicts the data flow through the architecture of the event projection system 318, illustrating how calibrated interaction data leads to marketing action. Store 322 represents the retail environment where product interactions occur, generating receipts that are captured via consumer-facing applications, point-of-sale systems, or loyalty app integrations. These receipts form part of the event-based interaction dataset 312, which is routed to the system's projection and calibration engine 302. While valuable, this data is often sparse or inconsistent due to technical limitations or user submission behavior.

To fill in these gaps, the system ingests transaction data from third-party financial data sources. Credit Card Provider 1 (324) and Credit Card Provider 2 (326) provide respective transaction log datasets 314 and 320. These may originate from card networks, banks, or open banking APIs and can vary in format, completeness, and data structure. The event projection system 318 normalizes and merges these datasets, ensuring consistency and identifying gaps between the interaction dataset and broader transaction activity.

Within system 318, the machine learning module 316 evaluates user-level and store-level discrepancies, learning from past observation patterns to build predictive models. It identifies unreported interaction events based on temporal gaps, merchant aliases, or frequency mismatches, and dynamically generates projection factors tailored to each retail location, product category, or consumer segment. These projection factors are then applied to generate the calibrated dataset, providing a foundation for targeting strategies rooted in corrected behavior.

Once the corrected data is available, the system initiates targeted media operations. For example, an ad campaign may be initiated for a newly qualified user 304, whose recalibrated interaction history now meets criteria for high-value targeting. This might include exposure to premium loyalty programs, bundled promotions, or geo-personalized offers across platforms.

For previously known users, the system can initiate retargeting 306. If a consumer engaged with a brand but did not complete a purchase—or did so in a way that was underreported—the system recognizes the opportunity for re-engagement and launches a tailored follow-up campaign. These retargeting efforts may involve ad placements across mobile, connected TV, or desktop environments, with timing and content optimized for recent inferred activity.

In some cases, the system may also recommend or trigger a new order of physical or digital content placements 308. For instance, if the projected dataset reveals high engagement for a product in a store that was previously believed to have low footfall, the system may recommend restocking point-of-sale displays or increasing digital signage coverage. This enables dynamic content orchestration based on current, corrected demand estimates.

The system can also modify the configuration of a targeted audience 310, adjusting frequency, content type, or channel mix. For example, if a user cohort previously appeared inactive but is now shown to be moderately active based on projection, the system may reassign them to a mid-tier engagement group for campaign inclusion. These shifts allow for smarter allocation of media spend and reduce unnecessary exposure to low-converting segments.

The system also accounts for store types known to have low receipt capture rates, such as fast food, vending, or self-checkout retail formats. By cross-referencing transaction log data with receipt coverage, the system flags probable gaps in merchant categories and corrects accordingly.

In some implementations, the system compares a user's behavior to broader behavioral cohorts to identify outliers. If the average user in a certain demographic uploads 10 receipts per month but one user only submits 3 despite similar transaction volume, the system detects this anomaly and adjusts the user profile accordingly.

The system further applies household-level calibration logic in cases where multiple individuals share a transaction instrument. If household behavior historically includes 12 purchase events per month, and only a small portion is captured in the event dataset, the system uses historical trends to fill in the missing gaps.

Lastly, regional discrepancies are considered. The system leverages regional economic and behavioral norms to assess whether certain DMAs are systematically underreporting. If high credit card volume coincides with minimal receipt activity, the system applies corrective projections to improve geographic targeting accuracy. These insights feed directly into media planning tools, enabling advertisers to optimize across both content delivery and campaign strategy.

### Projection Module

In some embodiments, the event projection system performs projections using one or more projection models, such as a machine learning model, to calculate a projection factor or generate a recalibrated dataset. The calibration process can be based on identifying discrepancies between structured datasets, including the event-based interaction dataset and a supplemental user activity dataset.

The system establishes a computational relationship between different streams of user activity data—such as receipt-like purchase signals and third-party data sources—by applying structured normalization and alignment techniques. Rather than relying solely on raw user-reported data, the system uses programmatic projection modeling to adjust for partial data coverage, ensuring that outputs reflect a more complete picture of consumer activity.

One key technical challenge addressed by the system is that the event-based interaction dataset and the supplemental user activity dataset may originate from disjoint systems with incompatible schemas and no shared identifiers. For instance, digital receipts collected from email, apps, or OCR sources may only represent a sample of total user behavior, while bank-level data or loyalty logs may provide broader frequency patterns without product-level granularity. These differences in structure, completeness, and origin complicate any naive comparison or integration.

To overcome this, the system implements a multi-step modeling pipeline that performs field mapping, data normalization, discrepancy detection, and projection factor calculation. The system resolves challenges associated with federated, non-communicating data environments—including missing records, inconsistently formatted timestamps, and anonymized user linkage.

The event-based interaction dataset may contain detailed product-level information such as SKUs, merchant names, timestamps, store identifiers, and purchase categories. The supplemental user activity dataset may include payment metadata, visit frequencies, merchant aliases, or temporal activity logs. These fields often use inconsistent representations, such as:
Event-Based Interaction Data: {“items”: [“Toothpaste”, “Shampoo”], “timestamp”: “2025-04-01T09:12:00Z”, “merchant”: “PharmaPlus Store #14”}
Supplemental Activity Data: {“amount”: 13.49, “datetime”: “2025-04-01 09:10”, “location”: “PHARMAPLUS-LOC875”, “channel”: “Mobile Wallet”}

The system harmonizes fields like timestamps, location formats, and merchant identifiers, and aligns item categories or visit records to enable side-by-side comparison. Once aligned, the system detects discrepancies—such as multiple inferred store visits from the supplemental dataset that do not have corresponding records in the interaction dataset.

At this stage, the system may invoke one or more projection models, which may include statistical rules, supervised classifiers, probabilistic discrepancy scorers, or hybrid ML models. For example, if the supplemental dataset shows four distinct shopping events at Store B, but only one purchase event appears in the interaction dataset, the system determines a 4× projection factor to account for underreporting. This factor can be refined further using attributes such as user demographics, retail type, interaction modality, or time window.

In some implementations, the system applies statistical models to approximate expected behavior distributions and infer likely omissions. Historical patterns around interaction completeness—such as app engagement, scanner usage, or store-specific reporting gaps—can be used to fine-tune user-level projection multipliers.

Once calculated, the projection factor is applied to the original event-based interaction dataset to produce a projected store-level dataset. This synthetic output better reflects aggregate consumer behavior and provides an accurate basis for downstream applications like ROI modeling, sales forecasting, product affinity mapping, or inventory planning. By grounding this calibration in structured statistical inference rather than assumptions, the system ensures higher confidence in the data outputs.

In some cases, projection modeling may include probabilistic scoring layers that assign confidence weights to each imputed value. For example, if a consumer typically visits a drugstore every Sunday but no event data is captured one weekend, the model may confidently infer a likely event occurred and generate a projected entry for that time gap with an associated confidence score.

The system supports calibration across multiple structural axes—including user ID, region, merchant, product category, and temporal slice—allowing for scalable, multi-resolution adjustment. This facilitates event projection at the store level, regional level (e.g., DMA), or within defined consumer segments to support various analytical or decision-making workflows.

Accordingly, the projection model module equips the system with the technical means to apply structured harmonization, cross-system normalization, and machine learning-driven estimation to reconstruct missing events and enhance the reliability of real-world consumer behavior analysis.

The interaction calibration system generates a calibrated electronic interaction dataset by applying a computed projection factor to the original electronic interaction data. This calibrated dataset serves as a corrected version of the user's observed purchase activity, offering a higher degree of accuracy for downstream analytical tasks. By mitigating the effects of data sparsity and underreporting, the system reduces the risk of drawing biased conclusions about user behavior, product affinity, or purchase frequency.

The calibration process begins when the system receives two distinct sources of data: electronic interaction data—such as itemized receipts submitted through scanning, app-based uploads, or email parsing—and transaction log data, such as credit card or bank account histories that reflect all recorded payment events. The system compares these datasets to detect discrepancies in the number, frequency, and timing of observed transactions. These differences reveal how much of the real-world consumer behavior is missing from the receipt-based dataset.

For instance, if a user submits only two grocery store receipts over the course of a month, but their transaction log shows eight separate purchases at that store during the same period, the system identifies a substantial underreporting gap. It calculates a projection factor—in this case, 4.0 (8÷2)—and applies it to scale the user's interaction data. This produces a calibrated dataset that more closely reflects the true scope of the user's purchasing behavior.

This projection factor can be tailored to a wide range of contextual dimensions, including user identity, store location, time period, product type, or submission modality (e.g., scanned receipt vs. email receipt). For example, one user might receive a projection factor of 1.5 for pharmacy receipts in January, but 3.0 for grocery purchases in March—depending on observed discrepancies in their respective transaction logs. The resulting calibrated interaction dataset corrects for these variations in data coverage, enabling a more representative and unbiased view of product-level engagement.

Calibrated data enhances the reliability of downstream applications such as brand penetration analysis, loyalty scoring, market share modeling, product switching detection, and geographic demand forecasting. By correcting for missing interactions, the system helps eliminate false negatives—e.g., mistakenly assuming a user did not purchase a product when in fact they did—and improves overall attribution fidelity. This enables retailers, marketers, and data analysts to make better-informed decisions, such as reallocating promotional budgets, refining audience targeting strategies, or optimizing inventory levels.

Ultimately, the system establishes a measurement framework that aligns more closely with real-world consumer behavior than traditional, uncorrected datasets. Through structured calibration informed by transaction logs and other supplementary data, the interaction calibration system transforms incomplete event-based interaction data into a robust analytic asset suitable for high-stakes business intelligence.

Once a projection factor is established, the interaction calibration system applies it to the original event-based interaction dataset—such as scanned or parsed receipts—to generate a calibrated version that more accurately reflects the user's full purchasing behavior. This calibrated dataset serves as an adjusted representation of real-world consumer activity and can be used for downstream analytics with significantly improved reliability and reduced bias.

For example, if a user's receipt data reflects two cereal purchases over a given period and the projection factor is calculated as 4, the system estimates approximately eight cereal interactions (rounded where appropriate) to reflect the likely total purchasing behavior. This expanded dataset enables more accurate analysis of metrics such as product penetration, shopping frequency, and brand loyalty, all grounded in a more complete view of consumer activity.

To improve accuracy, the system may consolidate transaction log data from multiple credit cards or financial accounts associated with the same user. This allows the system to account for purchases made across different payment instruments—such as personal and business credit cards—that would otherwise appear as separate user profiles. Through linkage mechanisms such as anonymized user IDs, hashed email addresses, shared device fingerprints, or loyalty account numbers, the system merges these data streams to produce a unified transaction history, thereby minimizing undercounting due to fragmented payment behavior.

In some embodiments, calibration can be performed across varying levels of aggregation. At the household level, users with overlapping addresses, devices, or payment methods can be grouped to account for shared purchasing behavior. For example, if one household member regularly submits receipts while another does not, the system applies a household-level projection factor to estimate missing transactions. At higher levels, such as ZIP code or designated market area (DMA), the system compares aggregate user-submitted interaction data with known population or sales density to identify regional underreporting and apply corrective scaling.

The system can also apply a top-down calibration model using retailer-reported sales as a reference point. For instance, if a grocery chain reports $2 million in quarterly sales and only $200,000 in user-submitted receipt data is captured for that same time period, the system uses this discrepancy to estimate projection factors at the store, region, or household level. This hierarchical correction reconciles receipt-level interaction data with aggregate business metrics to ensure consistent and proportional scaling across the entire dataset.

In addition to cross-device and multi-user integration, the system handles discrepancies across submission modalities. For instance, electronic receipts might be acquired through email parsing, app-based manual uploads, or OCR scans of physical paper receipts. If the email ingestion module captures five receipts for a user during a reporting window but the OCR channel detects none, the system identifies an underrepresentation in scanned paper receipts and attributes it to user behavior or technical limitations. Modality-aware calibration ensures that the projection factors account for submission channel bias and maintain uniformity across heterogeneous data inputs.

The interaction calibration system may also access transaction log data from multiple, independently operated databases. For example, one transaction log database may be operated by a first payment processor and store structured data in JSON with embedded metadata, while another database from a bank or loyalty partner might store flat files in CSV format with distinct field names and merchant identifiers. These datasets may be independently managed and not directly interoperable.

To overcome this fragmentation, the system normalizes all transaction data to a common schema. This includes aligning merchant names, product categories, timestamp formats, payment instrument fields, and location metadata across sources. For example, if one database uses Eastern Time and the other uses UTC, the system converts both to a standard time zone. Similarly, abbreviated merchant codes are mapped to full merchant names using reference tables or natural language processing (NLP) techniques. This standardization enables the system to treat the data as a coherent, unified corpus suitable for analysis and calibration.

In architectures where the first and second transaction log systems do not natively communicate—such as data silos operated by different vendors or financial institutions—the interaction calibration system acts as the centralized reconciliation engine. By aggregating and harmonizing disparate datasets, the system establishes a consistent framework for detecting interaction gaps, estimating missing events, and scaling the data to match real-world behavior. This cross-platform interoperability enables the system to produce robust, multi-source calibrated datasets without requiring coordination between data providers.

### Machine Learning Calibration Module

The interaction calibration system may leverage one or more machine learning models to analyze, compare, and calibrate disparate datasets that record consumer behavior across multiple data channels. Because electronic interaction data (e.g., receipts) and transaction log data (e.g., credit card usage records) are collected independently and often lack a shared identifier, traditional rule-based models struggle to account for discrepancies, missing events, and reporting bias.

These issues limit the reliability of behavioral insights derived from raw data. To address these challenges, the system uses a trained machine learning model to detect gaps, assess likelihood of unreported activity, and dynamically generate correction weights (i.e., projection factors) that can be applied to interaction data.

The system's machine learning model may be trained on large-scale historical datasets that include known cases of partial interaction coverage and full transaction visibility. By analyzing such patterns, the model learns typical user behaviors—for instance, visit frequency, purchase cadence, and retailer preferences—and can then detect anomalies or deviations when interaction data is incomplete. If the model observes that a user typically visits a grocery store 10 times per month based on transaction log data but only has 3 receipt records, it can infer that 70% of interactions are unreported. It can then generate a corresponding projection factor for that user, specific store, or product category. This dynamic weighting allows the system to calibrate the dataset with higher precision than static mathematical assumptions.

In some cases, the machine learning model also evaluates contextual and behavioral variables to estimate the source and scope of underreporting. These variables may include receipt submission modality (e.g., photo scan vs. email receipt), payment instrument type (e.g., debit card, credit card, loyalty account), retailer-specific behavior patterns (e.g., likelihood of providing printed vs. digital receipts), or demographic indicators (e.g., reporting bias by age, income, or geography). The model incorporates these factors to generate nuanced correction values at the individual, household, regional, or merchant level. For example, if certain retailers or geographic regions show a higher discrepancy rate in user-submitted receipt data, the model may apply a higher projection factor for interactions associated with those contexts.

Beyond discrepancy detection and projection factor determination, the machine learning model can also support downstream calibration. Specifically, the system can use the model to generate a calibrated electronic interaction dataset by selectively amplifying or discounting certain entries based on confidence scores, behavioral modeling, or historic reporting accuracy. For example, if the model predicts with high certainty that a user's receipt history is underreported for a specific brand, the system can increase the weight of those brand-level interactions in the final dataset. Conversely, if a particular user consistently submits comprehensive receipts but only for specific merchants, the model may avoid over-projecting those entries. By continuously learning from new data, the system maintains up-to-date calibration logic that evolves with changing user behaviors, submission trends, and payment technologies.

Overall, the machine learning calibration module plays a vital role in ensuring that data integrity and reporting coverage are maximized, enabling more accurate consumer analytics, market penetration analysis, and product performance evaluation. Rather than relying on broad assumptions or heuristic projections, the system applies data-driven modeling techniques that scale with diverse data sources, support real-time calibration, and minimize bias across users, retailers, and channels.

### Geofencing-Based Calibration

In some implementations, the interaction calibration system incorporates geofencing or mobile-derived store visitation data to enhance detection of underreported consumer interactions. This data, sourced from a user's mobile device via GPS, Wi-Fi, or Bluetooth signals, enables the system to infer physical presence at specific retail locations even in the absence of corresponding electronic receipts or transaction records.

For example, if the system detects that a user visited a particular store seven times in a month based on geofencing logs, but only three receipts were submitted or matched in the electronic interaction dataset, the system identifies a likely discrepancy. From this, it may calculate a projection factor of approximately 2.33 (7÷3), which is then applied to scale the receipt data and estimate total purchase volume more accurately.

Geofencing data is particularly valuable in cases where gaps arise due to user behavior (e.g., forgetting to upload a receipt), merchant practices (e.g., not offering digital receipts), or technical failures (e.g., OCR or parsing errors). While geolocation data does not confirm that a purchase occurred, it serves as a strong behavioral indicator of shopping activity. To improve confidence, the system may cross-reference geofenced store visits with transaction log data—such as credit card histories or loyalty app usage—to verify that an economic exchange likely occurred during the visit.

The system may further refine its calibration logic using visit-specific metadata, such as duration and time-of-day. For example, a brief visit under two minutes may be weighted less heavily or excluded, whereas a 30-minute visit may increase the likelihood that a purchase occurred. These heuristics are continuously improved using population-level training data to better align geofenced visits with actual purchasing behavior.

Geofencing-derived projection factors can also be calculated at the group or regional level. For instance, if geolocation data shows 1,000 total visits to a store in ZIP Code 90210 over a given month but only 400 receipts were submitted, the system may apply a regional projection factor of 3.33 to compensate for the shortfall in recorded interactions. This is especially useful in low-instrumentation areas or among demographics with lower receipt submission rates.

Because geofencing alone does not reveal product-level detail or confirm purchase, it is treated as one signal within a multi-modal calibration framework. The interaction calibration system integrates geolocation signals with other behavioral indicators—such as credit card data, receipt modality patterns, and historical user profiles—to assign more accurate projection weights. This layered approach improves calibration accuracy and supports more reliable downstream tasks such as behavioral segmentation, market share analysis, or ad performance measurement.

By accounting for observed physical presence—even in the absence of digital transaction data—the system reduces bias introduced by incomplete receipt coverage, enabling a more statistically grounded and inclusive view of consumer engagement.

### Machine Architecture

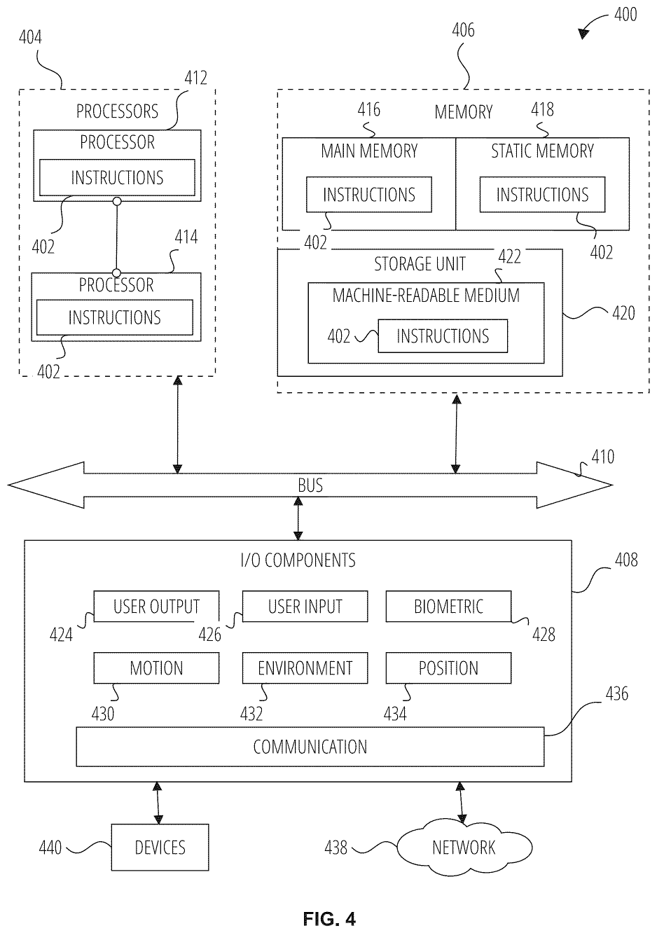

FIG. 4 is a diagrammatic representation of the machine 400 within which instructions 402 (e.g., software, a program, an application, an applet, an app, or other executable code) for causing the machine 400 to perform any one or more of the methodologies discussed herein may be executed. For example, the instructions 402 may cause the machine 400 to execute any one or more of the methods described herein. The instructions 402 transform the general, non-programmed machine 400 into a particular machine 400 programmed to carry out the described and illustrated functions in the manner described. The machine 400 may operate as a standalone device or may be coupled (e.g., networked) to other machines. In a networked deployment, the machine 400 may operate in the capacity of a server machine or a client machine in a server-client network environment, or as a peer machine in a peer-to-peer (or distributed) network environment. The machine 400 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 402, sequentially or otherwise, that specify actions to be taken by the machine 400. Further, while a single machine 400 is illustrated, the term “machine” shall also be taken to include a collection of machines that individually or jointly execute the instructions 402 to perform any one or more of the methodologies discussed herein. The machine 400, for example, may comprise a user system or any one of multiple server devices forming part of the server system. In some examples, the machine 400 may also comprise both client and server systems, with certain operations of a particular method or algorithm being performed on the server-side and with certain operations of the particular method or algorithm being performed on the client-side.

The machine 400 may include processors 404, memory 406, and input/output I/O components 408, which may be configured to communicate with each other via a bus 410. In an example, the processors 404 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, a processor 412 and a processor 414 that execute the instructions 402. The term “processor” is intended to include multi-core processors that may comprise two or more independent processors (sometimes referred to as “cores”) that may execute instructions contemporaneously. Although FIG. 4 shows multiple processors 404, the machine 400 may include a single processor with a single-core, a single processor with multiple cores (e.g., a multi-core processor), multiple processors with a single core, multiple processors with multiples cores, or any combination thereof.

The memory 406 includes a main memory 416, a static memory 418, and a storage unit 420, both accessible to the processors 404 via the bus 410. The main memory 406, the static memory 418, and storage unit 420 store the instructions 402 embodying any one or more of the methodologies or functions described herein. The instructions 402 may also reside, completely or partially, within the main memory 416, within the static memory 418, within machine-readable medium 422 within the storage unit 420, within at least one of the processors 404 (e.g., within the processor's cache memory), or any suitable combination thereof, during execution thereof by the machine 400.

The I/O components 408 may include a wide variety of components to receive input, provide output, produce output, transmit information, exchange information, capture measurements, and so on. The specific I/O components 408 that are included in a particular machine will depend on the type of machine. For example, portable machines such as mobile phones may include a touch input device or other such input mechanisms, while a headless server machine will likely not include such a touch input device. It will be appreciated that the I/O components 408 may include many other components that are not shown in FIG. 4. In various examples, the I/O components 408 may include user output components 424 and user input components 426. The user output components 424 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 426 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

In further examples, the I/O components 408 may include medical device components 628, motion components 430, environmental components 432, or position components 434, among a wide array of other components. For example, the medical device components 628 include components to detect data from medical devices, as further described herein.

The motion components 430 include acceleration sensor components (e.g., accelerometer), gravitation sensor components, rotation sensor components (e.g., gyroscope).

The environmental components 432 include, for example, one or more cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gasses for safety or to measure pollutants in the atmosphere), or other components that may provide indications, measurements, or signals corresponding to a surrounding physical environment.

The position components 434 include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 408 further include communication components 436 operable to couple the machine 400 to a network 438 or devices 440 via respective coupling or connections. For example, the communication components 436 may include a network interface component or another suitable device to interface with the network 438. In further examples, the communication components 436 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 440 may be another machine or any of a wide variety of peripheral devices (e.g., a peripheral device coupled via a USB).

Moreover, the communication components 436 may detect identifiers or include components operable to detect identifiers. For example, the communication components 436 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph™, MaxiCode, PDF417, Ultra Code, UCC RSS-2D bar code, and other optical codes), or acoustic detection components (e.g., microphones to identify tagged audio signals). In addition, a variety of information may be derived via the communication components 436, such as location via Internet Protocol (IP) geolocation, location via Wi-Fi® signal triangulation, location via detecting an NFC beacon signal that may indicate a particular location, and so forth.

The various memories (e.g., main memory 416, static memory 418, and memory of the processors 404) and storage unit 420 may store one or more sets of instructions and data structures (e.g., software) embodying or used by any one or more of the methodologies or functions described herein. These instructions (e.g., the instructions 402), when executed by processors 404, cause various operations to implement the disclosed examples.

The instructions 402 may be transmitted or received over the network 438, using a transmission medium, via a network interface device (e.g., a network interface component included in the communication components 436) and using any one of several well-known transfer protocols (e.g., hypertext transfer protocol (HTTP)). Similarly, the instructions 402 may be transmitted or received using a transmission medium via a coupling (e.g., a peer-to-peer coupling) to the devices 440.

### Software Architecture

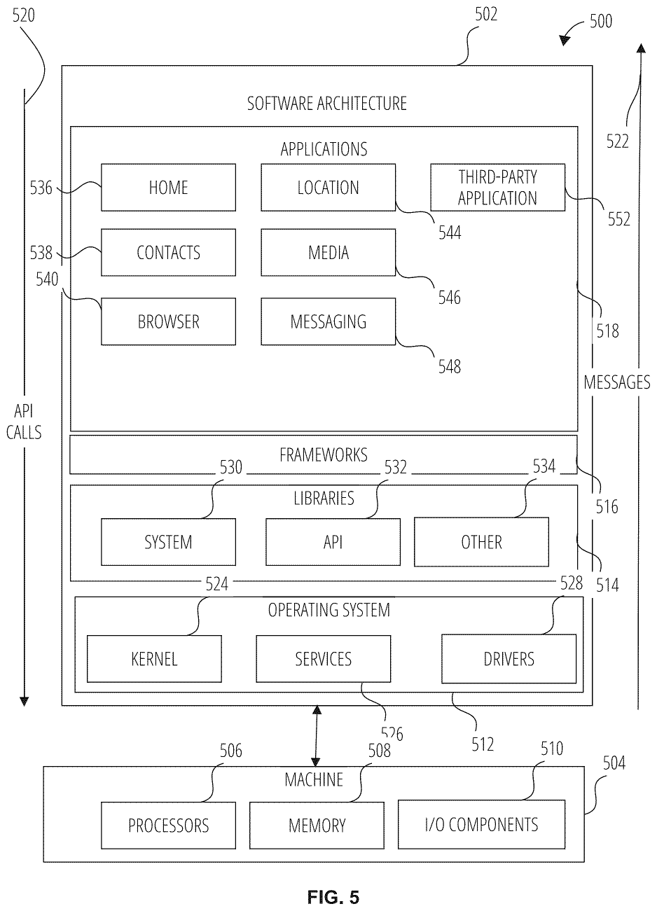

FIG. 5 is a block diagram 500 illustrating a software architecture 502, which can be installed on any one or more of the devices described herein. The software architecture 502 is supported by hardware such as a machine 504 that includes processors 506, memory 508, and I/O components 510. In this example, the software architecture 502 can be conceptualized as a stack of layers, where each layer provides a particular functionality. The software architecture 502 includes layers such as an operating system 512, libraries 514, frameworks 516, and applications 518. Operationally, the applications 518 invoke API calls 520 through the software stack and receive messages 522 in response to the API calls 520.

The operating system 512 manages hardware resources and provides common services. The operating system 512 includes, for example, a kernel 524, services 526, and drivers 528.

The kernel 524 acts as an abstraction layer between the hardware and the other software layers. For example, the kernel 524 provides memory management, processor management (e.g., scheduling), component management, networking, and security settings, among other functionalities. The services 526 can provide other common services for the other software layers. The drivers 528 are responsible for controlling or interfacing with the underlying hardware. For instance, the drivers 528 can include display drivers, camera drivers, BLUETOOTH® or BLUETOOTH® Low Energy drivers, flash memory drivers, serial communication drivers (e.g., USB drivers), WI-FI® drivers, audio drivers, power management drivers, and so forth.

The libraries 514 provide a common low-level infrastructure used by the applications 518. The libraries 514 can include system libraries 530 (e.g., C standard library) that provide functions such as memory allocation functions, string manipulation functions, mathematic functions, and the like. In addition, the libraries 514 can include API libraries 532 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 514 can also include a wide variety of other libraries 534 to provide many other APIs to the applications 518.

The frameworks 516 provide a common high-level infrastructure that is used by the applications 518. For example, the frameworks 516 provide various graphical user interface (GUI) functions, high-level resource management, and high-level location services. The frameworks 516 can provide a broad spectrum of other APIs that can be used by the applications 518, some of which may be specific to a particular operating system or platform.

In an example, the applications 518 may include a home application 536, a contacts application 538, a browser application 540, a location application 544, a media application 546, a messaging application 548, and a broad assortment of other applications such as a third-party application 552. The applications 518 are programs that execute functions defined in the programs. Various programming languages can be employed to create one or more of the applications 518, structured in a variety of manners, such as object-oriented programming languages (e.g., Objective-C, Java, or C++) or procedural programming languages (e.g., C or assembly language). In a specific example, the third-party application 552 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 552 can invoke the API calls 520 provided by the operating system 512 to facilitate functionalities described herein.

### Machine-Learning Pipeline

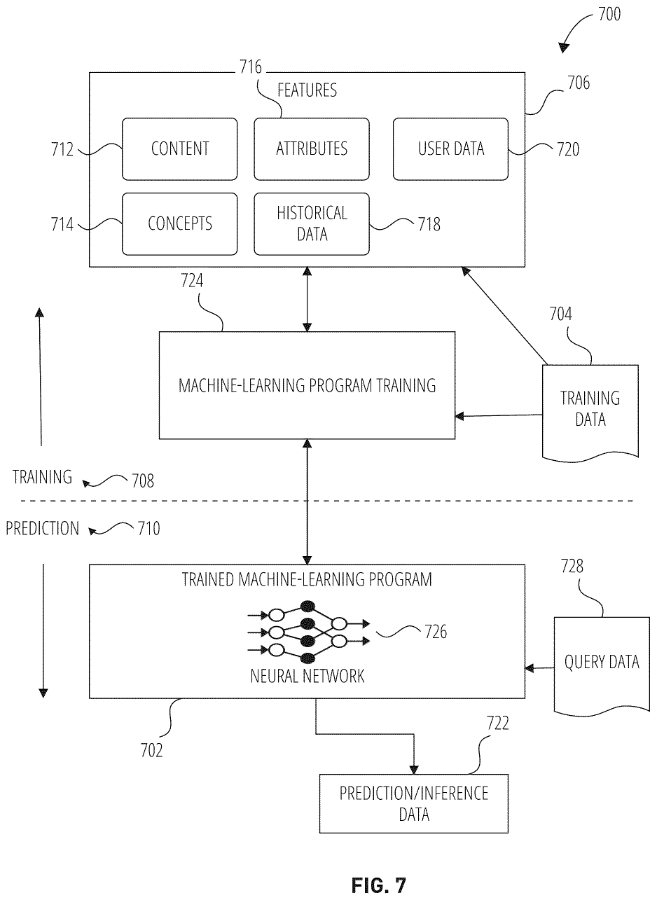

FIG. 7 is a flowchart depicting a machine-learning pipeline 700, according to some examples. The machine-learning pipelines 700 may be used to generate a trained model, for example the trained machine-learning program 702 of FIG. 7, described herein to perform operations associated with searches and query responses.

### Overview

Broadly, machine learning may involve using computer algorithms to automatically learn patterns and relationships in data, potentially without the need for explicit programming to do so after the algorithm is trained. Examples of machine learning algorithms can be divided into three main categories: supervised learning, unsupervised learning, and reinforcement learning.
Supervised learning involves training a model using labeled data to predict an output for new, unseen inputs. Examples of supervised learning algorithms include linear regression, decision trees, and neural networks.
Unsupervised learning involves training a model on unlabeled data to find hidden patterns and relationships in the data. Examples of unsupervised learning algorithms include clustering, principal component analysis, and generative models like autoencoders.
Reinforcement learning involves training a model to make decisions in a dynamic environment by receiving feedback in the form of rewards or penalties. Examples of reinforcement learning algorithms include Q-learning and policy gradient methods.

Examples of specific machine learning algorithms that may be deployed, according to some examples, include logistic regression, which is a type of supervised learning algorithm used for binary classification tasks. Logistic regression models the probability of a binary response variable based on one or more predictor variables. Another example type of machine learning algorithm is Naïve Bayes, which is another supervised learning algorithm used for classification tasks. Naïve Bayes is based on Bayes' theorem and assumes that the predictor variables are independent of each other. Random Forest is another type of supervised learning algorithm used for classification, regression, and other tasks. Random Forest builds a collection of decision trees and combines their outputs to make predictions. Further examples include neural networks which consist of interconnected layers of nodes (or neurons) that process information and make predictions based on the input data. Matrix factorization is another type of machine learning algorithm used for recommender systems and other tasks. Matrix factorization decomposes a matrix into two or more matrices to uncover hidden patterns or relationships in the data. Support Vector Machines (SVM) are a type of supervised learning algorithm used for classification, regression, and other tasks. SVM finds a hyperplane that separates the different classes in the data. Other types of machine learning algorithms include decision trees, k-nearest neighbors, clustering algorithms, and deep learning algorithms such as convolutional neural networks (CNN), recurrent neural networks (RNN), and transformer models. The choice of algorithm depends on the nature of the data, the complexity of the problem, and the performance requirements of the application.

The performance of machine learning models is typically evaluated on a separate test set of data that was not used during training to ensure that the model can generalize to new, unseen data. Evaluating the model on a separate test set helps to mitigate the risk of overfitting, a common issue in machine learning where a model learns to perform exceptionally well on the training data but fails to maintain that performance on data it hasn't encountered before. By using a test set, the system obtains a more reliable estimate of the model's real-world performance and its potential effectiveness when deployed in practical applications.

Although several specific examples of machine learning algorithms are discussed herein, the principles discussed herein can be applied to other machine learning algorithms as well. Deep learning algorithms such as convolutional neural networks, recurrent neural networks, and transformers, as well as more traditional machine learning algorithms like decision trees, random forests, and gradient boosting may be used in various machine learning applications.

Two example types of problems in machine learning are classification problems and regression problems. Classification problems, also referred to as categorization problems, aim at classifying items into one of several category values (for example, is this object an apple or an orange?). Regression algorithms aim at quantifying some items (for example, by providing a value that is a real number).

### Phases

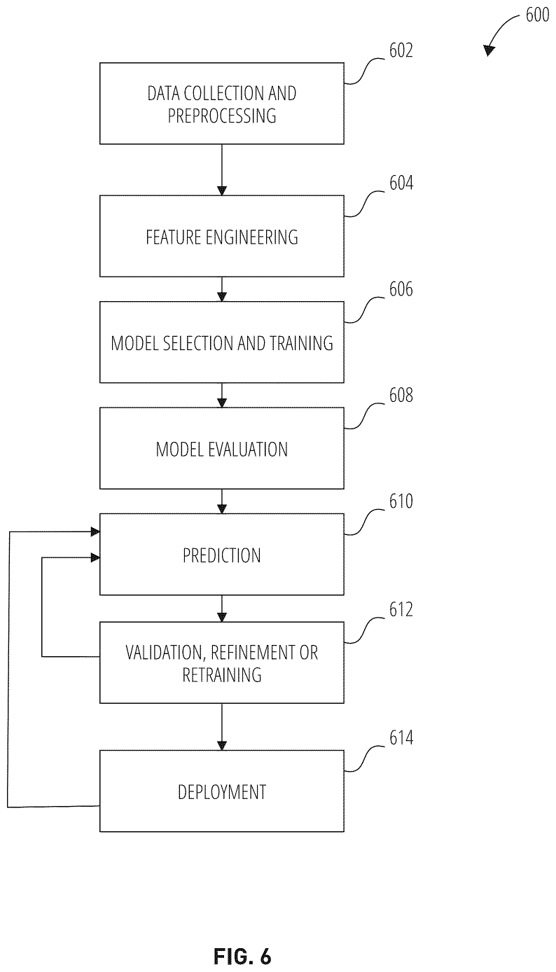

Generating a trained machine-learning program 702 may include multiple types of phases that form part of the machine-learning pipeline 700, including for example the following phases 600 illustrated in FIG. 6:
Data collection and preprocessing 602: This may include acquiring and cleaning data to ensure that it is suitable for use in the machine learning model. Data can be gathered from user content creation and labeled using a machine learning algorithm trained to label data. Data can be generated by applying a machine learning algorithm to identify or generate similar data. This may also include removing duplicates, handling missing values, and converting data into a suitable format.
Feature engineering 604: This may include selecting and transforming the training data 704 to create features that are useful for predicting the target variable. Feature engineering may include (1) receiving features 706 (e.g., as structured or labeled data in supervised learning) and/or (2) identifying features 706 (e.g., unstructured or unlabeled data for unsupervised learning) in training data 704.
Model selection and training 606: This may include specifying a particular problem or desired response from input data, selecting an appropriate machine learning algorithm, and training it on the preprocessed data. This may further involve splitting the data into training and testing sets, using cross-validation to evaluate the model, and tuning hyperparameters to improve performance. Model selection can be based on factors such as the type of data, problem complexity, computational resources, or desired performance.
Model evaluation 608: This may include evaluating the performance of a trained model (e.g., the trained machine-learning program 702) on a separate testing dataset. This can help determine if the model is overfitting or underfitting and if it is suitable for deployment.
Prediction 610: This involves using a trained model (e.g., trained machine-learning program 702) to generate predictions on new, unseen data.
Validation, refinement or retraining 612: This may include updating a model based on feedback generated from the prediction phase, such as new data or user feedback.
Deployment 614: This may include integrating the trained model (e.g., the trained machine-learning program 702) into a larger system or application, such as a web service, mobile app, or IoT device. This can involve setting up APIs, building a user interface, and ensuring that the model is scalable and can handle large volumes of data.

FIG. 7 illustrates two example phases, namely a training phase 708 (part of the model selection and trainings 706) and a prediction phase 710 (part of prediction 710). Prior to the training phase 708, feature engineering 704 is used to identify features 706. This may include identifying informative, discriminating, and independent features for the effective operation of the trained machine-learning program 702 in pattern recognition, classification, and regression. In some examples, the training data 704 includes labeled data, which is known data for pre-identified features 706 and one or more outcomes.

Each of the features 706 may be a variable or attribute, such as individual measurable property of a process, article, system, or phenomenon represented by a data set (e.g., the training data 704). Features 706 may also be of different types, such as numeric features, strings, vectors, matrices, encodings, and graphs, and may include one or more of content 712, concepts 714, attributes 716, historical data 718 and/or user data 720, merely for example.

Concept features can include abstract relationships or patterns in data, such as determining a topic of a document or discussion in a chat window between users. Content features include determining a context based on input information, such as determining a context of a user based on user interactions or surrounding environmental factors. Context features can include text features, such as frequency or preference of words or phrases, image features, such as pixels, textures, or pattern recognition, audio classification, such as spectrograms, and/or the like.

Attribute features include intrinsic attributes (directly observable) or extrinsic features (derived), such as identifying square footage, location, or age of a real estate property identified in a camera feed. User data features include data pertaining to a particular individual or to a group of individuals, such as in a geographical location or that share demographic characteristics. User data can include demographic data (such as age, gender, location, or occupation), user behavior (such as browsing history, purchase history, conversion rates, click-through rates, or engagement metrics), or user preferences (such as preferences to certain video, text, or digital content items). Historical data includes past events or trends that can help identify patterns or relationships over time.

In training phases 708, the machine-learning pipeline 700 uses the training data 704 to find correlations among the features 706 that affect a predicted outcome or prediction/inference data 722.

With the training data 704 and the identified features 706, the trained machine-learning program 702 is trained during the training phase 708 during machine-learning program training 724. The machine-learning program training 724 appraises values of the features 706 as they correlate to the training data 704. The result of the training is the trained machine-learning program 702 (e.g., a trained or learned model).

Further, the training phase 708 may involve machine learning, in which the training data 704 is structured (e.g., labeled during preprocessing operations), and the trained machine-learning program 702 implements a relatively simple neural network 726 capable of performing, for example, classification and clustering operations. In other examples, the training phase 708 may involve deep learning, in which the training data 704 is unstructured, and the trained machine-learning program 702 implements a deep neural network 726 that is able to perform both feature extraction and classification/clustering operations.

A neural network 726 may, in some examples, be generated during the training phase 708, and implemented within the trained machine-learning program 702. The neural network 726 includes a hierarchical (e.g., layered) organization of neurons, with each layer including multiple neurons or nodes. Neurons in the input layer receive the input data, while neurons in the output layer produce the final output of the network. Between the input and output layers, there may be one or more hidden layers, each including multiple neurons.

Each neuron in the neural network 726 operationally computes a small function, such as an activation function that takes as input the weighted sum of the outputs of the neurons in the previous layer, as well as a bias term. The output of this function is then passed as input to the neurons in the next layer. If the output of the activation function exceeds a certain threshold, an output is communicated from that neuron (e.g., transmitting neuron) to a connected neuron (e.g., receiving neuron) in successive layers. The connections between neurons have associated weights, which define the influence of the input from a transmitting neuron to a receiving neuron. During the training phase, these weights are adjusted by the learning algorithm to optimize the performance of the network. Different types of neural networks may use different activation functions and learning algorithms, which can affect their performance on different tasks. Overall, the layered organization of neurons and the use of activation functions and weights enable neural networks to model complex relationships between inputs and outputs, and to generalize to new inputs that were not seen during training.

In some examples, the neural network 726 may also be one of a number of different types of neural networks or a combination thereof, such as a single-layer feed-forward network, a Multilayer Perceptron (MLP), an Artificial Neural Network (ANN), a Recurrent Neural Network (RNN), a Long Short-Term Memory Network (LSTM), a Bidirectional Neural Network, a symmetrically connected neural network, a Deep Belief Network (DBN), a Convolutional Neural Network (CNN), a Generative Adversarial Network (GAN), an Autoencoder Neural Network (AE), a Restricted Boltzmann Machine (RBM), a Hopfield Network, a Self-Organizing Map (SOM), a Radial Basis Function Network (RBFN), a Spiking Neural Network (SNN), a Liquid State Machine (LSM), an Echo State Network (ESN), a Neural Turing Machine (NTM), or a Transformer Network, merely for example.

In addition to the training phase 708, a validation phase may be performed evaluated on a separate dataset known as the validation dataset. The validation dataset is used to tune the hyperparameters of a model, such as the learning rate and the regularization parameter. The hyperparameters are adjusted to improve the performance of the model on the validation dataset.

The neural network 726 is iteratively trained by adjusting model parameters to minimize a specific loss function or maximize a certain objective. The system can continue to train the neural network 726 by adjusting parameters based on the output of the validation, refinement, or retraining block 712, and rerun the prediction 710 on new or already run training data. The system can employ optimization techniques for these adjustments such as gradient descent algorithms, momentum algorithms, Nesterov Accelerated Gradient (NAG) algorithm, and/or the like. The system can continue to iteratively train the neural network 726 even after deployment 714 of the neural network 726. The neural network 726 can be continuously trained as new data emerges, such as based on user creation or system-generated training data.

Once a model is fully trained and validated, in a testing phase, the model may be tested on a new dataset that the model has not seen before. The testing dataset is used to evaluate the performance of the model and to ensure that the model has not overfit the training data.

In prediction phase 710, the trained machine-learning program 702 uses the features 706 for analyzing query data 728 to generate inferences, outcomes, or predictions, as examples of a prediction/inference data 722. For example, during prediction phase 710, the trained machine-learning program 702 is used to generate an output. Query data 728 is provided as an input to the trained machine-learning program 702, and the trained machine-learning program 702 generates the prediction/inference data 722 as output, responsive to receipt of the query data 728. Query data can include a prompt, such as a user entering a textual question or speaking a question audibly. In some cases, the system generates the query based on an interaction function occurring in the system, such as a user interacting with a virtual object, a user sending another user a question in a chat window, or an object detected in a camera feed.

In some examples the trained machine-learning program 702 may be a generative AI model. Generative AI is a term that may refer to any type of artificial intelligence that can create new content from training data 704. For example, generative AI can produce text, images, video, audio, code or synthetic data that are similar to the original data but not identical.

Some of the techniques that may be used in generative AI are:
Convolutional Neural Networks (CNNs): CNNs are commonly used for image recognition and computer vision tasks. They are designed to extract features from images by using filters or kernels that scan the input image and highlight important patterns. CNNs may be used in applications such as object detection, facial recognition, and autonomous driving.
Recurrent Neural Networks (RNNs): RNNs are designed for processing sequential data, such as speech, text, and time series data. They have feedback loops that allow them to capture temporal dependencies and remember past inputs. RNNs may be used in applications such as speech recognition, machine translation, and sentiment analysis
Generative adversarial networks (GANs): These are models that consist of two neural networks: a generator and a discriminator. The generator tries to create realistic content that can fool the discriminator, while the discriminator tries to distinguish between real and fake content. The two networks compete with each other and improve over time. GANs may be used in applications such as image synthesis, video prediction, and style transfer.
Variational autoencoders (VAEs): These are models that encode input data into a latent space (a compressed representation) and then decode it back into output data. The latent space can be manipulated to generate new variations of the output data. They may use self-attention mechanisms to process input data, allowing them to handle long sequences of text and capture complex dependencies.
Transformer models: These are models that use attention mechanisms to learn the relationships between different parts of input data (such as words or pixels) and generate output data based on these relationships. Transformer models can handle sequential data such as text or speech as well as non-sequential data such as images or code.

In generative AI examples, the prediction/inference data 722 that is output include trend assessment and predictions, translations, summaries, image or video recognition and categorization, natural language processing, face recognition, user sentiment assessments, advertisement targeting and optimization, voice recognition, or media content generation, recommendation, and personalization.

### EXAMPLES

In view of the above-described implementations of subject matter this application discloses the following list of examples, wherein one feature of an example in isolation or more than one feature of an example, taken in combination and, optionally, in combination with one or more features of one or more further examples are further examples also falling within the disclosure of this application.

Example 1 is a method performed by one or more hardware processors, the method comprising: accessing electronic interaction data associated with a first user, the interaction data associated with an interaction by the first user with one or more products or services of an entity; accessing transaction log data for the first user, the transaction log data including transactions made by the first user using a transaction instrument; identifying a discrepancy between the electronic interaction data and the transaction log data; determining a projection factor for the first user based on the identified discrepancy; and generating a calibrated electronic interaction dataset by applying the projection factor to the electronic interaction data.

In Example 2, the subject matter of Example 1 includes, wherein at least a portion of the electronic interaction data is captured using a camera on a mobile device of the first user.

In Example 3, the subject matter of Examples 1-2 includes, wherein at least a portion of the electronic interaction data is generated by a point of sale device in a location of the entity.

In Example 4, the subject matter of Examples 1-3 includes, wherein the transaction log data includes purchases made by the first user using the transaction instrument with the entity, wherein the transaction log data includes the entity and time of the transaction, but does not include an itemized list of goods or services purchased.

In Example 5, the subject matter of Examples 1-4 includes, wherein identifying the discrepancy includes identifying a discrepancy in a number of interactions by the first user in the electronic interaction data with the entity and a number of transactions in the transaction log data by the first user with the entity in a period of time.

In Example 6, the subject matter of Examples 1-5 includes, wherein the method further comprises: accessing location data of a mobile device of the first user; and determining a number of visits that the first user visited a location of the entity based on the location data; wherein determining the projection factor is further based on the determined number of visits.

In Example 7, the subject matter of Examples 1-6 includes, wherein the electronic interaction data and the transaction log data is further associated with a plurality of users, wherein the calibrated electronic interaction dataset is for the plurality of users.

In Example 8, the subject matter of Example 7 includes, wherein the plurality of users is located in a particular geographical area.

In Example 9, the subject matter of Examples 7-8 includes, wherein the plurality of users completed a transaction at a particular location of the entity.

In Example 10, the subject matter of Examples 1-9 includes, wherein the electronic interaction data includes receipt data, the method further comprises: identifying a first subset of receipt data of a first receipt type; and identifying a second subset of receipt data of a second receipt type; wherein the projection factor is further based on the first subset of the first receipt type and the second subset of the second receipt type.

In Example 11, the subject matter of Examples 1-10 includes, wherein a first subset and a second subset of the transaction log data is accessed by one or more hardware processors from a first transaction log database and a second transaction log database, respectively, the first transaction log database and the second transaction log database being external to the one or more hardware processors, wherein first subset being in a different data format than the second subset, the method further comprising: normalizing the first subset and the second subset.

In Example 12, the subject matter of Example 11 includes, wherein a first transaction log system associated with the first subset does not have direct communication with a second transaction log system associated with the second subset.

In Example 13, the subject matter of Examples 1-12 includes, wherein identifying the discrepancy, determining the projection factor, and generating the calibrated electronic interaction dataset is based on inputting the electronic interaction data and the transaction log data into a machine learning model, the machine learning model being trained to generate calibrated electronic interaction datasets based on inputted interaction and transaction log data.

In Example 14, the subject matter of Examples 1-13 includes, wherein the method further comprises modifying an ad campaign based on calibrated electronic interaction dataset.

In Example 15, the subject matter of Examples 1-14 includes, wherein determining the projection factor further comprises: accessing publicly available retail revenue data, including an annual or quarterly revenue value for a merchant location from a financial disclosure source; accessing aggregated electronic interaction data and transaction log data for the merchant location; and determining the projection factor based on a ratio between the revenue value from the financial disclosure source and a sum of corresponding transaction values from the interaction data and the transaction log data for the merchant location.

In Example 16, the subject matter of Examples 1-15 includes, wherein determining the projection factor further comprises: identifying a geographic region associated with the first user, the region comprising a zip code or a Designated Market Area (DMA); aggregating transaction log data and interaction data corresponding to the geographic region; and determining the projection factor based on a ratio between a total value from the transaction log data and a total value from the interaction data for the geographic region.

In Example 17, the subject matter of Examples 1-16 includes, wherein determining the projection factor further comprises: aggregating transaction log data for the first user across one or more transaction instruments; aggregating interaction data for the first user; and computing a household-specific projection factor based on a discrepancy between a number of transactions in the transaction log data and a number of interactions in the interaction data for the first user.

In Example 18, the subject matter of Examples 1-17 includes, wherein identifying the discrepancy comprises analyzing geolocation data from a mobile device associated with the first user to determine a number of store visits by the first user, and wherein the projection factor is further based on a difference between the number of store visits and the number of interactions in the electronic interaction data.

Example 19 is a system comprising: at least one processor; and at least one memory component storing instructions that, when executed by the at least one processor, cause the at least one processor to perform operations comprising: accessing electronic interaction data associated with a first user, the interaction data associated with an interaction by the first user with one or more products or services of an entity; accessing transaction log data for the first user, the transaction log data including transactions made by the first user using a transaction instrument; identifying a discrepancy between the electronic interaction data and the transaction log data; determining a projection factor for the first user based on the identified discrepancy; and generating a calibrated electronic interaction dataset by applying the projection factor to the electronic interaction data.

Example 20 is a non-transitory computer-readable storage medium storing instructions that, when executed by at least one processor, cause the at least one processor to perform operations comprising: accessing electronic interaction data associated with a first user, the interaction data associated with an interaction by the first user with one or more products or services of an entity; accessing transaction log data for the first user, the transaction log data including transactions made by the first user using a transaction instrument; identifying a discrepancy between the electronic interaction data and the transaction log data; determining a projection factor for the first user based on the identified discrepancy; and generating a calibrated electronic interaction dataset by applying the projection factor to the electronic interaction data.

Example 21 is at least one machine-readable medium including instructions that, when executed by processing circuitry, cause the processing circuitry to perform operations to implement any of Examples 1-20.

Example 22 is an apparatus comprising means to implement any of Examples 1-20.

Example 23 is a system to implement any of Examples 1-20.

Example 24 is a method to implement any of Examples 1-20.

### Conclusion

Unless the context clearly requires otherwise, throughout the description and the claims, the words “comprise,” “comprising,” and the like are to be construed in an inclusive sense, as opposed to an exclusive or exhaustive sense, i.e., in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words using the singular or plural number may also include the plural or singular number respectively. The word “or” in reference to a list of two or more items, covers all of the following interpretations of the word: any one of the items in the list, all of the items in the list, and any combination of the items in the list. Likewise, the term “and/or” in reference to a list of two or more items, covers all of the following interpretations of the word: any one of the items in the list, all of the items in the list, and any combination of the items in the list.

Although some examples, e.g., those depicted in the drawings, include a particular sequence of operations, the sequence may be altered without departing from the scope of the present disclosure. For example, some of the operations depicted may be performed in parallel or in a different sequence that does not materially affect the functions as described in the examples. In other examples, different components of an example device or system that implements an example method may perform functions at substantially the same time or in a specific sequence.

The various features, steps, and processes described herein may be used independently of one another, or may be combined in various ways. All possible combinations and subcombinations are intended to fall within the scope of this disclosure. In addition, certain method or process blocks may be omitted in some implementations.

In the example embodiments, it should be understood that the NFT system, the NFT system, and the various devices may be implemented in other manners. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected according to actual requirements to achieve the objectives of the solutions of the embodiments. In addition, functional units in the example embodiments may be integrated into one processing unit, or each of the units may exist alone physically, or two or more units may be integrated into one unit.

When the functions are implemented in the form of a software functional unit and sold or used as an independent product, the functions may be stored in a computer readable storage medium. Based on such an understanding, the technical solutions of example embodiments may be implemented in the form of a software product. The software product is stored in a storage medium, and includes several instructions for instructing a computing device to perform all or some of the steps or processes of the methods described in the example embodiments. The foregoing storage medium includes any medium that can store program code, such as a universal serial bus flash drive, removable hard disk, read only memory, random access memory, magnetic disc, and/or an optical disc.

In the described methods or block diagrams, boxes may represent events, steps, functions, processes, modules, messages, and/or state based operations, etc. While some of the example embodiments have been described as occurring in a particular order, some of the steps or processes may be performed in a different order provided that the result of the changed order of any given step will not prevent or impair the occurrence of subsequent steps. Furthermore, some of the messages or steps described may be removed or combined in other embodiments, and some of the messages or steps describe herein may be separated into a number of sub-messages or sub-steps in other embodiments. Even further, some or all of the steps may be repeated, as necessary. Elements described as methods, steps, or processes similarly apply to systems, subsystems, or subcomponents, and vice versa. Reference to such a word as sending or receiving could be interchanged depending on the perspective of the particulars device. The described embodiments are considered to be illustrative and not restrictive. Example embodiments described as methods would similarly apply to systems, subsystems, or devices, and vice versa.

The various example embodiments are merely examples and are in no way meant to limit the scope of this disclosure. Variations of the innovations describe herein will be apparent to persons of ordinary skill in the art, such variations being within the intended scope. In particular features from one or more of the example embodiments may be selected to create alternative embodiments comprised of a sub-combination of features which may not be explicitly described. In addition, features from one or more of the described example embodiments may be selected and combined to create alternative example embodiments comprised of a combination of features which may not be explicitly described. Features suitable for such combinations and sub-combinations would be readily apparent a person skilled in the art. The subject matter describe herein intends to cover all suitable changes in technology.

1. A method performed by one or more hardware processors, the method comprising:
accessing electronic interaction data associated with a first user, the electronic interaction data associated with an interaction by the first user with one or more products or services of an entity, the interaction data including itemized list of goods or services;
anonymizing the electronic interaction data by associating interactions of the first user with hash identifiers such that the first user is anonymized in the electronic interaction data;
accessing transaction log data for the first user, the transaction log data including historical transactions made by the first user using a transaction instrument, the transaction log data including purchases made by the first user using the transaction instrument with the entity, wherein the transaction log data includes the entity and time of the transaction, but does not include an itemized list of goods or services purchased;
inferring an increased number of historical purchases for a particular item of the itemized list within the transaction log data by inputting the anonymized electronic interaction data that includes the itemized list of goods or service with the transaction log data that does not include the itemized list of goods or services purchased into a machine learning model, the machine learning model being trained to infer an increased number of historical purchases within the transaction log data based on the anonymized electronic interaction data and the transaction log data;
accessing geolocation data of the first user that includes historical location data of the first user from a mobile device associated with the first user;
identifying a merchant location associated with the electronic interaction data;
determining a number of visitations by the first user to the merchant location based on the accessed geolocation data and the merchant location;
for each of the visitations by the first user determine a dwell time of the mobile device within the merchant location, the dwell time indicative of a length of time for the corresponding visitation;
determining a projection factor for the first user based on (1) the increased number of historical purchases, (2) the number of visitations by the first user to the merchant location, and (3) the dwell times associated with the visitations, the projection factor corresponding to a multiplicative factor corresponding to the inferred increase in the number of historical purchases already made by the first user;
generating a calibrated electronic interaction dataset by applying the multiplicative factor associated with the projection factor to the particular item in the electronic interaction data, the calibrated electronic interaction dataset including an inferred number of historical purchases absent in the electronic interaction data; and
continuously:
receiving updated electronic interaction data; and
retraining the machine learning model based on the updated electronic interaction data to continuously reflect updated behavior of the first user.

2. The method of claim 1, wherein at least a portion of the electronic interaction data is captured using a camera on a mobile device of the first user.

3. The method of claim 1, wherein at least a portion of the electronic interaction data is generated by a point of sale device in a location of the entity.

4. The method of claim 1, wherein the transaction log data includes purchases made by the first user using the transaction instrument with the entity, wherein the transaction log data includes the entity and time of the transaction, but does not include an itemized list of goods or services purchased.

5. The method of claim 1, wherein identifying the discrepancy includes identifying a discrepancy in a number of interactions by the first user in the electronic interaction data with the entity and a number of transactions in the transaction log data by the first user with the entity in a period of time.

6. The method of claim 1, wherein the method further comprises:
accessing location data of a mobile device of the first user; and
determining a number of visits that the first user visited a location of the entity based on the location data;
wherein determining the projection factor comprises inferring an increase in an interaction by the first user with at least one of the itemized list of goods or services is further based on the determined number of visits.

7. The method of claim 1, wherein the electronic interaction data and the transaction log data is further associated with a plurality of users, wherein the calibrated electronic interaction dataset is for the plurality of users.

8. The method of claim 7, wherein the plurality of users is located in a particular geographical area.

9. The method of claim 7, wherein the plurality of users completed a transaction at a particular location of the entity.

10. The method of claim 1, wherein the electronic interaction data includes receipt data, the method further comprises:
identifying a first subset of receipt data of a first receipt type; and
identifying a second subset of receipt data of a second receipt type;
wherein the projection factor is further based on the first subset of the first receipt type and the second subset of the second receipt type.

11. The method of claim 10, wherein a first subset and a second subset of the transaction log data is accessed by one or more hardware processors from a first transaction log database and a second transaction log database, respectively,
the first transaction log database and the second transaction log database being external to the one or more hardware processors,
wherein first subset being in a different data format than the second subset, the method further comprising:
normalizing the first subset and the second subset.

12. The method of claim 11, wherein a first transaction log system associated with the first subset does not have direct communication with a second transaction log system associated with the second subset.

13. The method of claim 1, wherein identifying the discrepancy, determining the projection factor, and generating the calibrated electronic interaction dataset is performed by based on inputting the electronic interaction data that includes the itemized list of goods or service with the transaction log data that does not include the itemized list of goods or services purchased into a machine learning model, the machine learning model being trained to receive as input the electronic interaction data that includes the itemized list of goods or service with the transaction log data that does not include the itemized list of goods or services purchased, the machine learning model being trained to generate calibrated electronic interaction datasets based on the inputted electronic interaction data and the transaction log data based on inferred increases to historical purchases within the transaction log data.

14. The method of claim 1, wherein the method further comprises modifying an ad campaign based on calibrated electronic interaction dataset which includes the at least one itemized list of goods or services where the multiplicative factor was applied, the modification of the ad campaign including one or more adjustments to bids submitted to an future ad campaign for display of an ad related to the at least one itemized list of goods or services.

15. The method of claim 1, wherein determining the projection factor further comprises:
accessing publicly available retail revenue data, including an annual or quarterly revenue value for a merchant location from a financial disclosure source;
accessing aggregated electronic interaction data and transaction log data for the merchant location; and
determining the projection factor based on a ratio between the revenue value from the financial disclosure source and a sum of corresponding transaction values from the interaction data and the transaction log data for the merchant location.

16. The method of claim 1, wherein determining the projection factor further comprises:
identifying a geographic region associated with the first user, the region comprising a zip code or a Designated Market Area (DMA);
aggregating transaction log data and interaction data corresponding to the geographic region; and
determining the projection factor based on a ratio between a total value from the transaction log data and a total value from the interaction data for the geographic region.

17. The method of claim 1, wherein determining the projection factor further comprises:
aggregating transaction log data for the first user across one or more transaction instruments;
aggregating interaction data for the first user; and
computing a household-specific projection factor based on a discrepancy between a number of transactions in the transaction log data and a number of interactions in the interaction data for the first user.

18. The method of claim 1, wherein identifying the discrepancy comprises analyzing geolocation data from a mobile device associated with the first user to determine a number of store visits by the first user, and wherein the projection factor is further based on a difference between the number of store visits and a number of interactions in the electronic interaction data.

19. A system comprising:
at least one processor; and
at least one memory component storing instructions that, when executed by the at least one processor, cause the at least one processor to perform operations comprising:
accessing electronic interaction data associated with a first user, the electronic interaction data associated with an interaction by the first user with one or more products or services of an entity, the interaction data including itemized list of goods or services;
anonymizing the electronic interaction data by associating interactions of the first user with hash identifiers such that the first user is anonymized in the electronic interaction data;
accessing transaction log data for the first user, the transaction log data including historical transactions made by the first user using a transaction instrument, the transaction log data including purchases made by the first user using the transaction instrument with the entity, wherein the transaction log data includes the entity and time of the transaction, but does not include an itemized list of goods or services purchased;
inferring an increased number of historical purchases for a particular item of the itemized list within the transaction log data by inputting the anonymized electronic interaction data that includes the itemized list of goods or service with the transaction log data that does not include the itemized list of goods or services purchased into a machine learning model, the machine learning model being trained to infer an increased number of historical purchases within the transaction log data based on the anonymized electronic interaction data and the transaction log data;
accessing geolocation data of the first user that includes historical location data of the first user from a mobile device associated with the first user;
identifying a merchant location associated with the electronic interaction data;
determining a number of visitations by the first user to the merchant location based on the accessed geolocation data and the merchant location;
for each of the visitations by the first user, determine a dwell time of the mobile device within the merchant location, the dwell time indicative of a length of time for the corresponding visitation;
determining a projection factor for the first user based on (1) the increased number of historical purchases, (2) the number of visitations by the first user to the merchant location, and (3) the dwell times associated with the visitations, the projection factor corresponding to a multiplicative factor corresponding to the inferred increase in the number of historical purchases already made by the first user;
generating a calibrated electronic interaction dataset by applying the multiplicative factor associated with the projection factor to the particular item in the electronic interaction data, the calibrated electronic interaction dataset including an inferred number of historical purchases absent in the electronic interaction data; and
continuously:
receiving updated electronic interaction data; and
retraining the machine learning model based on the updated electronic interaction data to continuously reflect updated behavior of the first user.

20. A non-transitory computer-readable storage medium storing instructions that, when executed by at least one processor, cause the at least one processor to perform operations comprising:
accessing electronic interaction data associated with a first user, the electronic interaction data associated with an interaction by the first user with one or more products or services of an entity, the interaction data including itemized list of goods or services;
anonymizing the electronic interaction data by associating interactions of the first user with hash identifiers such that the first user is anonymized in the electronic interaction data;
accessing transaction log data for the first user, the transaction log data including historical transactions made by the first user using a transaction instrument, the transaction log data including purchases made by the first user using the transaction instrument with the entity, wherein the transaction log data includes the entity and time of the transaction, but does not include an itemized list of goods or services purchased;
inferring an increased number of historical purchases for a particular item of the itemized list within the transaction log data by inputting the anonymized electronic interaction data that includes the itemized list of goods or service with the transaction log data that does not include the itemized list of goods or services purchased into a machine learning model, the machine learning model being trained to infer an increased number of historical purchases within the transaction log data based on the anonymized electronic interaction data and the transaction log data;
accessing geolocation data of the first user that includes historical location data of the first user from a mobile device associated with the first user;
identifying a merchant location associated with the electronic interaction data;
determining a number of visitations by the first user to the merchant location based on the accessed geolocation data and the merchant location;
for each of the visitations by the first user, determine a dwell time of the mobile device within the merchant location, the dwell time indicative of a length of time for the corresponding visitation;
determining a projection factor for the first user based on (1) the increased number of historical purchases, (2) the number of visitations by the first user to the merchant location, and (3) the dwell times associated with the visitations, the projection factor corresponding to a multiplicative factor corresponding to the inferred increase in the number of historical purchases already made by the first user;
generating a calibrated electronic interaction dataset by applying the multiplicative factor associated with the projection factor to the particular item in the electronic interaction data, the calibrated electronic interaction dataset including an inferred number of historical purchases absent in the electronic interaction data; and
continuously:
receiving updated electronic interaction data; and
retraining the machine learning model based on the updated electronic interaction data to continuously reflect updated behavior of the first user.
